(19) United States
(12) Patent Application Publication
(10) Pub. No.: US 2025/0287433 A1
(43) Pub. Date: Sep. 11, 2025

(54) SIGNALING FOR EARLY SRS TRIGGERING

(71) Applicant: Samsung Electronics Co., Ltd., Suwon-si (KR)

(72) Inventors: Emad Nader Farag, Flanders, NJ (US); Marian Rudolf, Longueuil (CA); Aristides Papasakellariou, Houston, TX (US); Eko Onggosanusi, Coppell, TX (US)

(21) Appl. No.: 19/060,412

(22) Filed: Feb. 21, 2025

Related U.S. Application Data
(60) Provisional application No. 63/563,110, filed on Mar. 8, 2024.
(60) Provisional application No. 63/565,366, filed on Mar. 14, 2024.
(60) Provisional application No. 63/678,912, filed on Aug. 2, 2024.
(60) Provisional application No. 63/745,138, filed on Jan. 14, 2025.

(51) Int. Cl. H04W 74/0838; H04L 5/00

(52) U.S. Cl. CPC H04W 74/0838; H04L 5/005

(57) ABSTRACT

Methods and apparatuses for signaling for early sounding reference signal (SRS) triggering. A method of operating a user equipment (UE) includes receiving a configuration for SRS resources and receiving a set of preambles for a random access procedure. The set of preambles is associated with transmission of a SRS when the UE supports transmission of the SRS in response to an indication associated with the random access procedure. The method further includes performing the random access procedure based on the set of preambles, receiving a message as part of the random access procedure that triggers transmission of the SRS, and transmitting the SRS on a SRS resource from the SRS resources in response to the message.

### CROSS-REFERENCE TO RELATED AND CLAIM OF PRIORITY

The present application claims priority under 35 U.S.C. § 119 (e) to U.S. Provisional Patent Application No. 63/563,110 filed on Mar. 8, 2024; U.S. Provisional Patent Application No. 63/565,366 filed on Mar. 14, 2024; U.S. Provisional Patent Application No. 63/678,912 filed on Aug. 2, 2024; and U.S. Provisional Patent Application No. 63/745,138 filed on Jan. 14, 2025, which are hereby incorporated by reference in their entirety.

### TECHNICAL FIELD

The present disclosure relates generally to wireless communication systems and, more specifically, the present disclosure relates to methods and apparatuses for signaling early sounding reference signal (SRS) triggering.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to signaling for early SRS triggering.

In one embodiment, a user equipment (UE) is provided. The UE includes a processor and a transceiver operably coupled to the processor. The transceiver is configured to receive a configuration for SRS resources and receive a set of preambles for a random access procedure. The set of preambles is associated with transmission of a SRS when the UE supports transmission of the SRS in response to an indication associated with the random access procedure. The transceiver is further configured to perform the random access procedure based on the set of preambles, receive a message as part of the random access procedure that triggers transmission of the SRS, and transmit the SRS on a SRS resource from the SRS resources in response to the message.

In another embodiment, a base station (BS) is provided. The BS includes a transceiver configured to transmit, to a UE, a configuration for SRS resources, transmit a configuration information for a set of preambles for a random access procedure, and receive a preamble from the set of preambles as part of the random access procedure. The set of preambles is associated with reception of a SRS in response to an indication associated with the random access procedure. The BS further includes a processor operably coupled to the transceiver. The processor is configured to determine a SRS resource from the SRS resources. The transceiver is further configured to transmit a message as part of the random access procedure that triggers transmission of the SRS and receive the SRS on the SRS resource in response to the message.

In yet another embodiment, a method of operating a UE is provided. The method includes receiving a configuration for SRS resources and receiving a set of preambles for a random access procedure. The set of preambles is associated with transmission of a SRS when the UE supports transmission of the SRS in response to an indication associated with the random access procedure. The method further includes performing the random access procedure based on the set of preambles, receiving a message as part of the random access procedure that triggers transmission of the SRS, and transmitting the SRS on a SRS resource from the SRS resources in response to the message.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a diagram of an example synchronization signal/physical broadcast channel (SS/PBCH) block according to embodiments of the present disclosure;

FIG. 8A illustrates a flowchart of an example contention based random access (CBRA) procedure according to embodiments of the present disclosure;

FIG. 8B illustrates a flowchart of an example contention free random access (CFRA) procedure according to embodiments of the present disclosure;

FIG. 9A illustrates a flowchart of an example CBRA procedure according to embodiments of the present disclosure;

FIG. 9B illustrates a flowchart of an example CFRA procedure according to embodiments of the present disclosure;

FIG. 10A illustrates a diagram of an example medium access control (MAC) random access procedure (RAR) for Type 1 random access procedure according to embodiments of the present disclosure;

FIGS. 10B and 10C illustrate diagrams of example MAC RAR for Type 2 random access procedure according to embodiments of the present disclosure;

FIG. 11 illustrates a flowchart of an example UE procedure for transmitting SRS according to embodiments of the present disclosure;

FIG. 12 illustrates a diagram of example subbands within a full band according to embodiments of the present disclosure;

FIGS. 13A, 13B, 13C, 13D, and 13E illustrate diagrams of example SRS transmission triggers according to embodiments of the present disclosure;

FIGS. 14A, 14B, and 14C illustrate diagrams of example SRS transmission identifiers according to embodiments of the present disclosure;

FIG. 15 illustrates a diagram of an example SRS resource configuration according to embodiments of the present disclosure; and

FIG. 16 illustrates an example method performed by a UE in a wireless communication system according to embodiments of the present disclosure.

### DETAILED DESCRIPTION

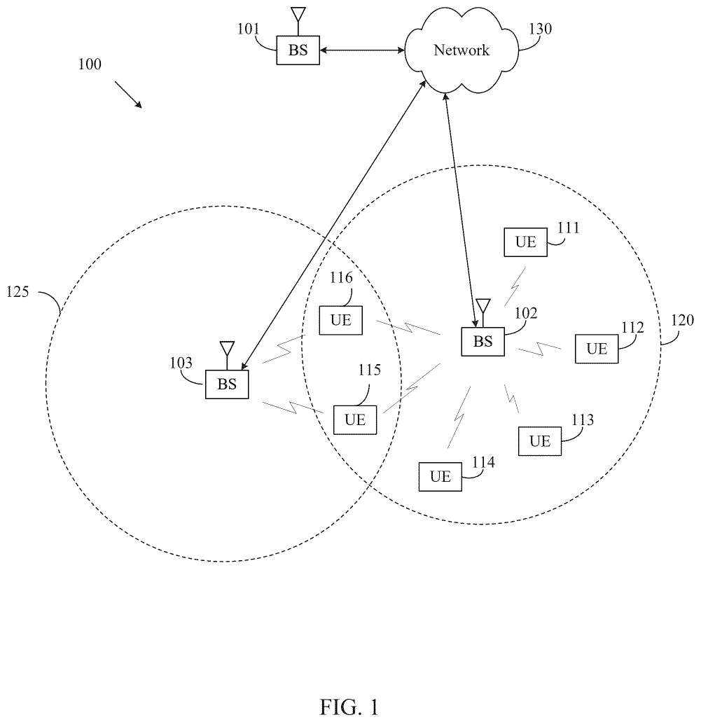

FIGS. 1-16, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF1] 3GPP TS 38.211 v18.1.0, “NR; Physical channels and modulation;” [REF2] 3GPP TS 38.212 v18.1.0, “NR; Multiplexing and Channel coding;” [REF3] 3GPP TS 38.213 v18.1.0, “NR; Physical Layer Procedures for Control;” [REF4] 3GPP TS 38.214 v18.1.0, “NR; Physical Layer Procedures for Data;” [REF5] 3GPP TS 38.321 v18.0.0, “NR; Medium Access Control (MAC) protocol specification;” and [REF6] 3GPP TS 38.331 v18.0.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103 (collectively forming a BS system). The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for signaling early SRS triggering. In certain embodiments, one or more of the gNBs 101-103 include circuitry, programing, or a combination thereof to support signaling for early SRS triggering.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

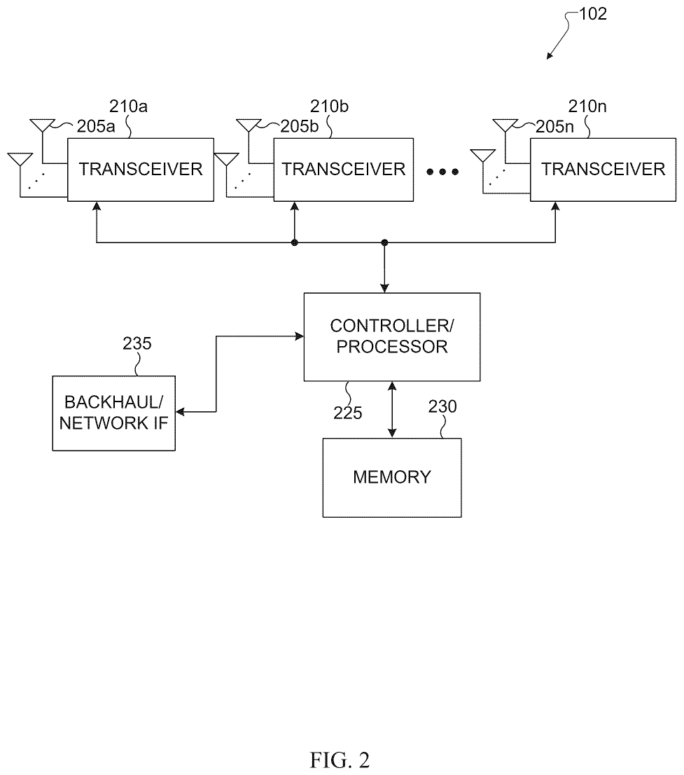

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting early SRS triggering. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM. Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

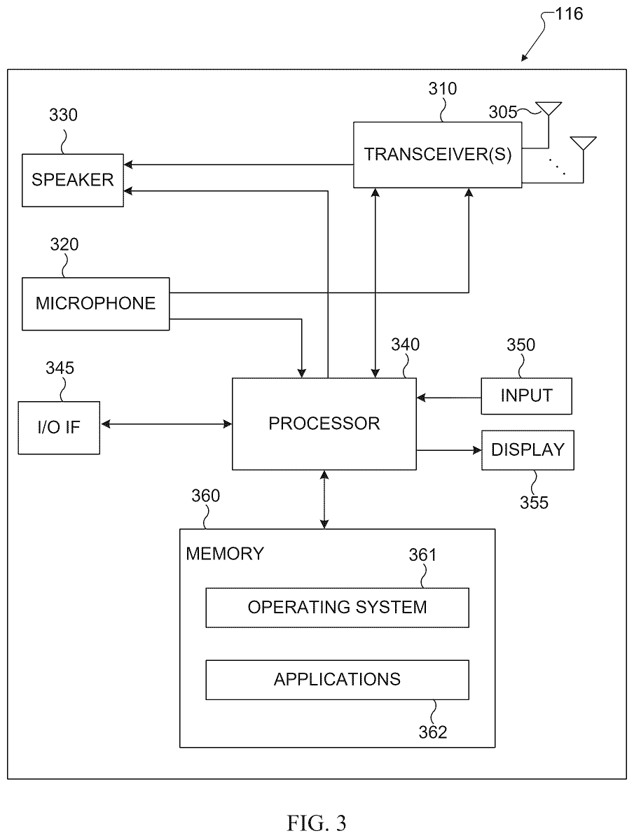

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for signaling early SRS triggering as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

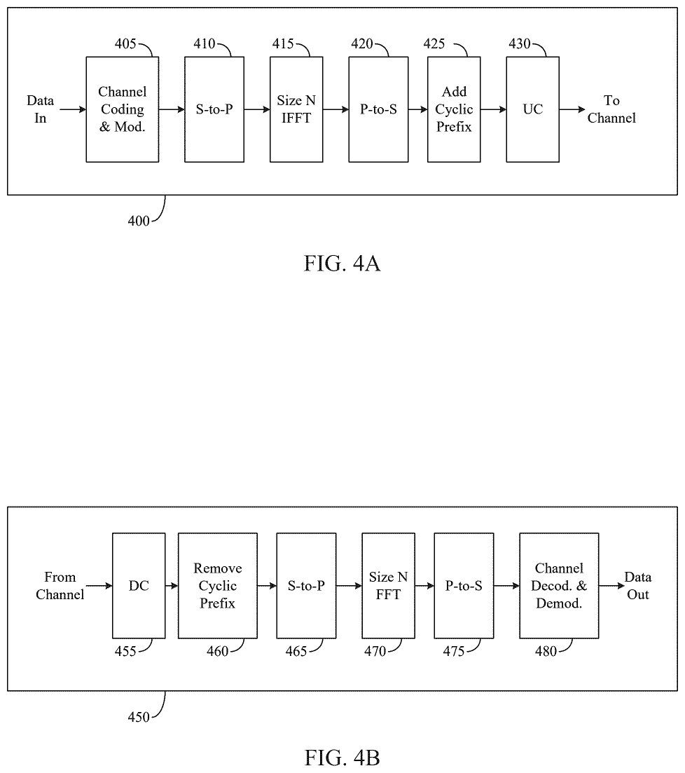

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 performs early SRS transmission as described in embodiments of the present disclosure. In some embodiments, the receive path 450 performs actions for receiving signaling for early SRS triggering as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

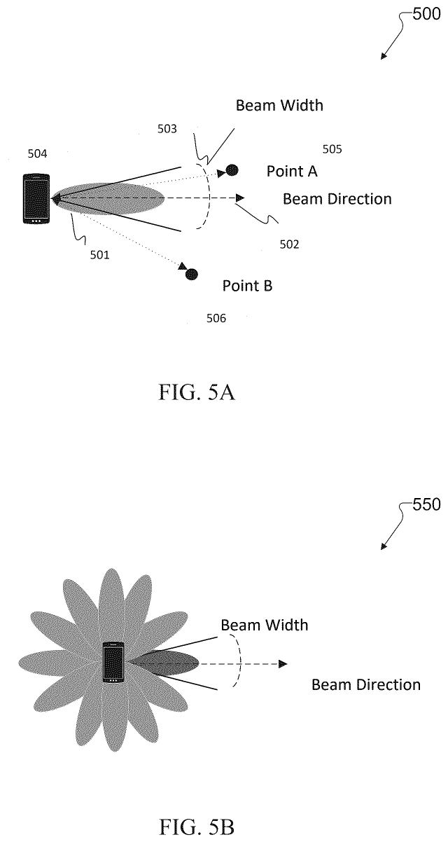

As illustrated in FIG. 5A, in a wireless system 500, a beam 501 for a device 504 can be characterized by a beam direction 502 and a beam width 503. For example, the device 504 (or UE 116) transmits RF energy in a beam direction 502 and within a beam width 503. The device 504 receives RF energy in a beam direction 502 and within a beam width 503. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While in FIG. 5B, for illustrative purposes, a beam is in 2D, it should be apparent to those skilled in the art, that a beam can be 3D, where a beam can be transmitted to or received from any direction in space.

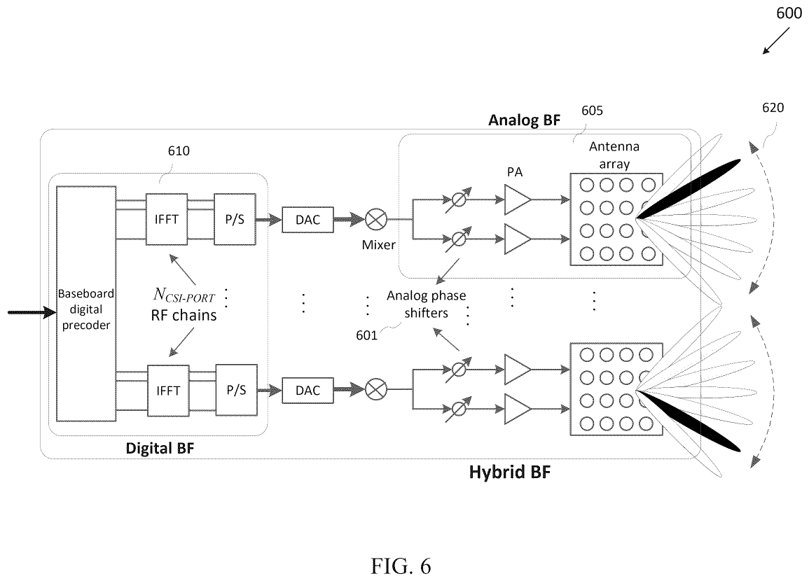

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only, and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for purposes of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O₂ absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while the figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

In this disclosure, a beam can be determined by any of;
A transmission configuration indication (TCI) state, that establishes a quasi-colocation (QCL) relationship or spatial relation between a source reference signal (e.g. synchronization signal block (SSB) and/or CSI-RS) and a target reference signal.
A spatial relation information that establishes an association to a source reference signal, such as SSB or CSI-RS or SRS.

In either case, the ID of the source reference signal or the ID of the TCI state or the ID of the spatial relation identifies the beam.

The TCI state and/or the spatial relation reference RS can determine a spatial Rx filter for reception of downlink channels at the UE, or a spatial Tx filter for transmission of uplink channels from the UE. The TCI state and/or the spatial relation reference RS can determine a spatial Tx filter for transmission of downlink channels from the gNB (e.g., the BS 102), or a spatial Rx filter for reception of uplink channels at the gNB.

Rel-17 introduced the unified TCI framework, where a unified or master or main or indicated TCI state is signaled to the UE. The unified or master or main or indicated TCI state can be one of:
1. In case of joint TCI state indication, wherein a same beam is used for DL and UL channels, a joint TCI state that can be used at least for UE-dedicated DL channels and UE-dedicated UL channels.
2. In case of separate TCI state indication, wherein different beams are used for DL and UL channels, a DL TCI state that can be used at least for UE-dedicated DL channels.
3. In case of separate TCI state indication, wherein different beams are used for DL and UL channels, a UL TCI state that can be used at least for UE-dedicated UL channels.

The unified (master or main or indicated) TCI state is TCI state of UE-dedicated reception on physical downlink shared channel (PDSCH)/physical downlink control channel (PDCCH) or dynamic-grant/configured-grant based physical uplink shared channel (PUSCH) and dedicated physical uplink control channel (PUCCH) resources.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state can be associated with a TRP of a cell having a PCI different from the PCI of the serving cell).

Quasi-co-location (QCL) relation, can be quasi-location with respect to one or more of the following relations [38.214—section 5.1.5] [REF4]:
Type A, {Doppler shift, Doppler spread, average delay, delay spread}
Type B, {Doppler shift, Doppler spread}
Type C, {Doppler shift, average delay}
Type D, {Spatial Rx parameter}

In addition, quasi-co-location relation and source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g. non-UE dedicated channel and sounding reference signal (SRS).

A UE (e.g., the UE 116) is indicated a TCI state by MAC CE when the MAC CE activates one TCI state code point. The UE applies the TCI state code point after a beam application time from the corresponding hybrid automatic repeat request acknowledgement (HARQ-ACK) feedback. A UE is indicated a TCI state by a DL related downlink control information (DCI) format (e.g., DCI Format 1_1, or DCI format 1_2), wherein the DCI format includes a “transmission configuration indication” field that includes a TCI state code point out of the TCI state code points activated by a MAC CE. A DL related DCI format can be used to indicate a TCI state when the UE is activated with more than one TCI state code points. The DL related DCI format can be with a DL assignment for PDSCH reception or without a DL assignment. A TCI state can also be indicated in a purpose designed channel or DCI Format for TCI state indication. A TCI state (TCI state code point) indicated in a DL related DCI format or purpose design channel or DCI Format for TCI state indication is applied after a beam application time from the corresponding HARQ-ACK feedback.

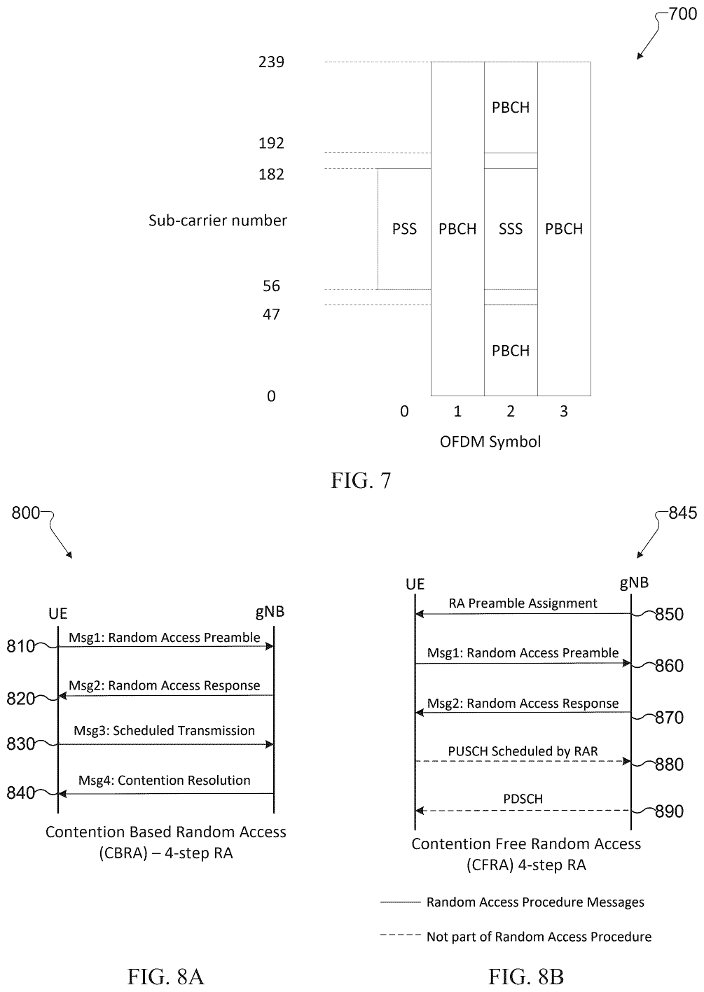

FIG. 7 illustrates a diagram of an example SS/PBCH block 700 according to embodiments of the present disclosure. For example, SS/PBCH block 700 can be utilized by any of the UEs 111-116 of FIG. 1. This example is for illustration only and other embodiments can be used without departing from the scope of the present disclosure.

In 5G/NR, a UE performs the cell search procedure to acquire time and frequency synchronization with a cell and to detect the physical layer Cell ID of the cell. To perform cell search, the UE receives the following signals and channel: (1) the primary synchronization signal (PSS), (2) the secondary synchronization signal (SSS) and (3) the physical broadcast channel (PBCH). A PSS/SSS/PBCH block (SS/PBCH block) is referred to as SSB and includes 4 consecutive symbols, and 20 resource blocks (RBs) (240 subcarriers), as illustrated in FIG. 7.

SSBs are organized in groups or bursts of up to N SSBs, transmitted within half a frame, each SSB within the group or burst has an index i, where i=0, 1, . . . , N−1, within each group or burst of SSBs, the SSBs are time-division multiplexed and arranged in increasing order of i, with increasing time. For carrier frequencies less than or equal to 3 GHZ, N=4. For carrier frequencies in FR1 that are larger than 3 GHz, N=8. For carrier frequencies in FR2, N=64. The SSB indices actually transmitted are provided by ssb-PositionsInBurst in system information block one (SIB1) or in ServingCellConfigCommon.

SSBs are transmitted periodically, where the allowed periodicities are {5, 10, 20, 40, 80, 160} ms. In addition to cell search, SSBs can also be used for beam management related procedures, such as new beam acquisition, beam measurements, and beam failure detection and recovery. Each SSB with index i can be associated with a spatial domain filter (or beam).

NR introduced a physical random access channel (PRACH) to be used, among other cases, when the UE wants to communicate with the network (e.g., the network 130) and doesn't have uplink resources. For example, the physical random access channel can be used during initial access. The PRACH includes a preamble format comprising one or more preamble sequences transmitted in a PRACH Occasion (RO).

NR supports four different preamble sequence lengths:
Sequence length 839 used with sub-carrier spacings 1.25 kHz and 5 kHz with unrestricted or restricted sets.
Sequence length 139 used with sub-carrier spacings 15 kHz, 30 kHz, 60 kHz and 120 kHz with unrestricted sets.
Sequence length 571 used with sub-carrier spacing 30 kHz with unrestricted sets.
Sequence length 1151 used with sub-carrier spacing 15 kHz with unrestricted sets.

RACH preambles are transmitted in time-frequency resources PRACH Occasions (ROs). Each RO determines the time and frequency resources in which a preamble is transmitted, the resources allocated to an RO in the frequency domain (e.g., number of resource blocks (RBs)) and the resource allocated to an RO in the time domain (e.g., number of OFDMA symbols or number of slots), depend or the preamble sequence length, sub-carrier spacing of the preamble, sub-carrier spacing of the PUSCH in the UL bandwidth part (BWP), and the preamble format. Multiple PRACH Occasions can be FDMed in one time instance. This is indicated by higher layer parameter msg1-FDM. The time instances of the PRACH Occasions are determined by the higher layer parameter prach-ConfigurationIndex, and Tables 6.3.3.2-2, 6.3.3.2-3, and 6.3.3.2-4 of TS 38.211 v18.1.0 [REF1].

SSBs are associated with ROs. The number of SSBs associated with one RO can be indicated by higher layer parameters such as ssb-perRACH-OccasionAndCB-PreamblesPerSSB and ssb-perRACH-Occasion. The number of SSBs per RO can be {⅛, ¼, ½, 1, 2, 4, 8, 16}. When the number of SSBs per RO is less than 1, multiple ROs are associated with the same SSB index. SS/PBCH block indexes provided by ssb-PositionsInBurst in SIB1 or in ServingCellConfigCommon are mapped to valid PRACH occasions in the following order [38.213 v18.1.0] [REF3]:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

The association period starts from frame 0 for mapping SS/PBCH block indexes to PRACH Occasions.

FIG. 8A illustrates a flowchart of an example contention-based random access (CBRA) procedure 800 according to embodiments of the present disclosure. For example, CBRA procedure 800 can be performed by the UE 116 and the gNB 102 and/or network 130 in the wireless network 100 of FIG. 1. This example is for illustration only and other embodiments can be used without departing from the scope of the present disclosure.

The procedure begins in 810, a UE transmits a Msg1: random access preamble to a gNB. In 820, the gNB transmits a Msg2: random access response to the UE. In 830, the UE transmits a Msg3: scheduled transmission to the gNB. In 840, the gNB transmits Msg4: content resolution to the UE.

FIG. 8B illustrates a flowchart of an example contention-free random access (CFRA) procedure 845 according to embodiments of the present disclosure. For example, CFRA procedure 845 can be performed by the UE 116 and the gNB 103 and/or network 130 in the wireless network 100 of FIG. 1. This example is for illustration only and other embodiments can be used without departing from the scope of the present disclosure.

The procedure begins in 850, a gNB transmits a RA preamble assignment to a UE. In 860, the UE transmits a Msg1: random access preamble to the gNB. In 870, the gNB transmits a Msg2: random access response to the UE. In 880, the UE may transmit a PUSCH scheduled by random access response (RAR) to the gNB. In 890, gNB may transmit PDSCH to the UE.

A random access procedure can be initiated by a PDCCH order, by the MAC entity, or by RRC.

There are two types of random access procedures, type-1 random access procedure and type-2 random access procedure.

Type-1 random access procedure also known as four-step random access procedure (4-step RACH), is as illustrated in FIGS. 8A and 8B;
In step 1, the UE transmits a random access preamble, also known as Msg1, to the gNB. The gNB attempts to receive and detect the preamble.
In step 2, the gNB upon receiving the preamble transmits a random access response (RAR), also known as Msg2, to the UE including, among other fields, a time adjustment (TA) command and a RAR uplink grant for a subsequent PUSCH transmission.
In step 3, the UE after receiving the RAR, transmits a PUSCH transmission scheduled by the grant of the RAR and time adjusted according to the TA received in the RAR. Msg3 or the PUSCH scheduled by the RAR UL grant can include the RRC reconfiguration complete message.
In step 4, the gNB upon receiving the RRC reconfiguration complete message, allocates downlink and uplink resources that are transmitted in a downlink PDSCH transmission to the UE.

After the last step, the UE can proceed with reception and transmission of data traffic.

Type-1 random access procedure (4-step RACH) can be contention based random access (CBRA) or contention free random access (CFRA). The CFRA procedure ends after the random access response, the following messages are not part of the random access procedure. For CFRA, in step 0, the gNB indicates to the UE the preamble to use.

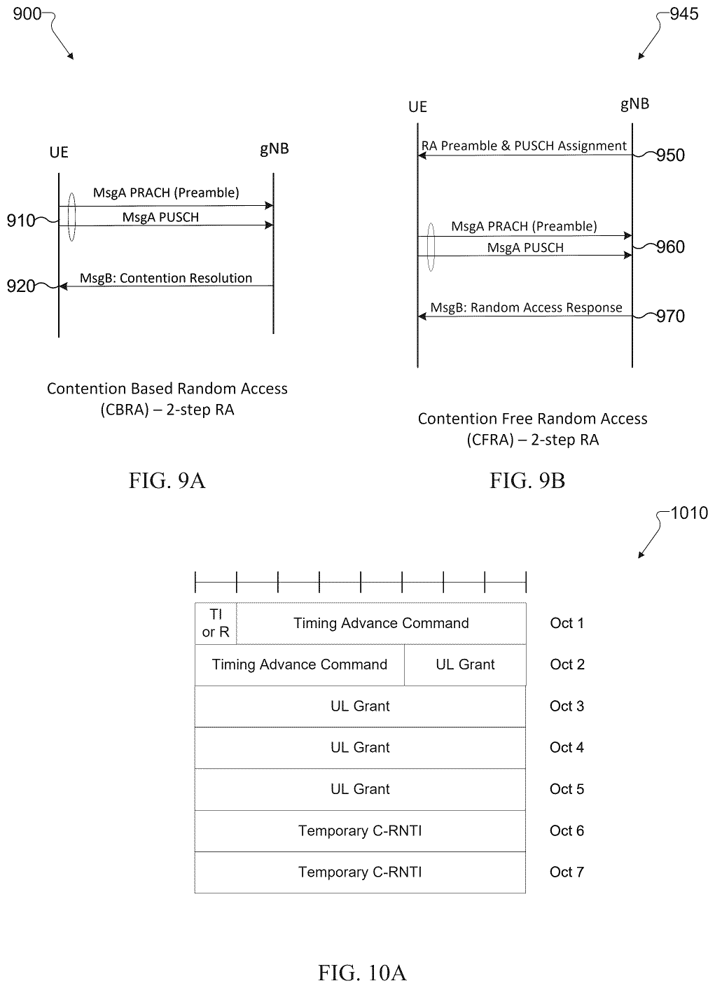

FIG. 9A illustrates a flowchart of an example CBRA procedure 900 according to embodiments of the present disclosure. For example, CBRA procedure 900 can be performed by the UE 115 and the gNB 102 and/or network 130 in the wireless network 100 of FIG. 1. This example is for illustration only and other embodiments can be used without departing from the scope of the present disclosure.

The procedure begins in 910, a UE transmits MsgA PRACH (preamble) and MsgA PUSCH to a gNB. In 920, the gNB transmits MsgB: contention resolution to the UE.

FIG. 9B illustrates a flowchart of an example CFRA procedure 945 according to embodiments of the present disclosure. For example, CFRA procedure 945 can be performed by the UE 115 and the gNB 103 and/or network 130 in the wireless network 100 of FIG. 1. This example is for illustration only and other embodiments can be used without departing from the scope of the present disclosure.

The procedure begins in 950, a gNB transmits a RA preamble and PUSCH assignment to a UE. In 960, the UE transmits MsgA PRACH (preamble) and MsgA PUSCH to the gNB. In 970, the gNB transmits MsgB: random access response to the UE.

Rel-16, introduced a new random access procedure; Type-2 random access procedure, also known as 2-step random access procedure (2-step RACH), is as illustrated in FIGS. 9A and 9B, that combines the preamble and PUSCH transmission into a single transmission from the UE to the gNB, which is known as MsgA. Similarly, the RAR and the PDSCH transmission (e.g. Msg4) are combined into a single downlink transmission from the gNB to the UE, which is known as MsgB.

A random access procedure can be triggered for initial access from the RRC_IDLE state. During this procedure, a UE identifies an SS/PBCH block with index i and with a reference signal received power (RSRP) that exceeds a threshold. The RSRP threshold for SSB selection for RACH resource association is indicated by the network. The UE selects a RO and a preamble within the RO associated with SS/PBCH block index i. The UE transmits a PRACH using the selected RO/preamble. The UE monitors and receives the random access response (RAR), by attempting to detect a DCI format 1_0 with cyclic redundancy check (CRC) scrambled by a corresponding RANDOM ACCESS radio network temporary identifier (RA-RNTI) during a window controlled by higher layers. If the UE does not detect the DCI format 1_0 with CRC scrambled by the corresponding RA-RNTI within the RAR window, the UE may retransmit PRACH. If the UE detects the DCI format 1_0 with CRC scrambled by the corresponding RA-RNTI, the UE receives a RAR UL grant for the scheduling of a PUSCH. The UE transmits the PUSCH according to the RAR UL grant. In response to the PUSCH transmission scheduled by a RAR UL grant, when a UE has not been provided a cell RNTI (C-RNTI), the UE attempts to detect a DCI format 1_0 with CRC scrambled by a corresponding temporary cell-radio network temporary identifier (TC-RNTI) scheduling a PDSCH that includes a UE contention resolution identity. The spatial domain filters (beams) identified during initial access, are used for subsequent transmissions and receptions to/from the UE until a single TCI state is configured or activated or indicated to the UE. For downlink receptions when a UE does not have the TCI state, the spatial domain filter is that associated with the SS/PBCH block index identified during initial access. For uplink transmissions when a UE does not have the TCI state, the spatial domain filter is that used for PUSCH scheduled by the RAR UL grant.

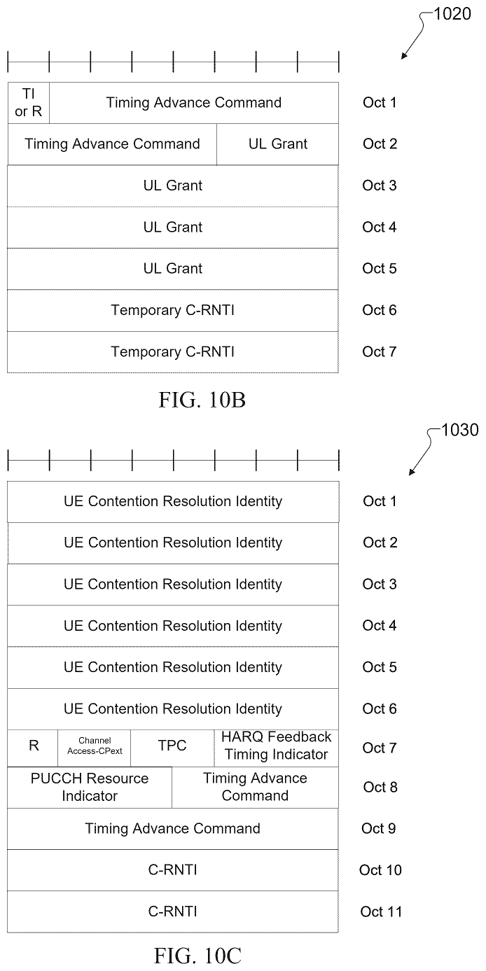

FIG. 10A illustrates a diagram of an example MAC RAR 1010 for Type 1 random access procedure according to embodiments of the present disclosure. For example, MAC RAR 1010 for Type 1 random access procedure can be received by any of the UEs 111-116 of FIG. 1, such as the UE 111. This example is for illustration only and other embodiments can be used without departing from the scope of the present disclosure.

FIGS. 10B and 10C illustrate diagrams of example MAC RAR 1020 and 1030 for Type 2 random access procedure according to embodiments of the present disclosure. For example, MAC RAR 1020 and 1030 for Type 2 random access procedure can be received by any of the UEs 111-116 of FIG. 1, such as the UE 116. This example is for illustration only and other embodiments can be used without departing from the scope of the present disclosure.

The MAC RAR (for Type 1 random access procedure) includes the 12-bit Timing Advance command is as illustrated in FIG. 10A (TS 38.321 [REF5] FIG. 6.2.3-1). Where,
R: Reserved bit, set to 0
TI: If two TAGs are configured for the Serving Cell in which the Random Access procedure is being performed, this field indicates one of the two TAGs to which the Timing Advance Command is applied

The fallback RAR (for Type 2 random access procedure), which is used when MSGA PRACH is successfully received but MSGA PUSCH is not decoded correctly, includes the 12-bit Timing Advance command is as illustrated in FIG. 10B (38.321 [REF5] FIG. 6.2.3a-1), Where,
R: Reserved bit, set to 0
TI: If two TAGs are configured for the SpCell, this field indicates one of the two TAGs to which the Timing Advance Command is applied

The success RAR (for Type 2 random access procedure), which is used when MSGA PRACH is successfully received and MSGA PUSCH is decoded correctly, includes the 12-bit Timing Advance command is as illustrated in FIG. 10C (38.321 [REF5] FIG. 6.2.3a-2)

In one example, the UL grant in the MAC RAR or fallbackRAR is given by Table 1:

TABLE 1

| RAR grant field | Number of bits |
|---|---|
| Frequency hopping flag | 1 |
| PUSCH frequency resource | 12, for operation with shared |
| allocation | spectrum channel access in FR1 |
| | or for FR2-2 when |
| | ChannelAccessMode2-r17 is |
| | provided 14, otherwise |
| PUSCH time resource allocation | 4 |
| MCS | 4 |
| TPC command for PUSCH | 3 |
| CSI request | 1 |
| ChannelAccess-CPext | 2, for operation with shared |
| | spectrum channel access in FR1 |
| | or for FR2-2 when |
| | ChannelAccessMode2-r17 is |
| | provided 0, otherwise |

Sounding reference signal is an uplink reference signal that is used for sounding (i.e., channel quality estimation) the uplink channel between the UE and the gNB. In case of reciprocity between UL and DL, the channel sounding of the uplink channel can also be used for link adaptation and precoding on the downlink channel from the gNB to the UE. SRS is transmitted independent of data transmissions on the uplink. The SRS usage can be one of: beamManagement, codebook, nonCodebook, antennaSwitching, this is in addition to SRS for positioning.

In NR SRS resources are configured by the network for example as part of RRC setup or RRC reconfiguration. SRS resources are configured in SRS resource set. An SRS resource set includes a set of SRS resource, and defines the following parameters: (1) resourceType, which determine the time domain behavior of SRS, SRS can be aperiodic, semi-persistent or periodic. (2) usage, which can be one of: beamManagement, codebook, nonCodebook or antennaSwitching. (3) information related to power control and TCI state.

The configuration of the SRS resource includes the following: (1) information related to the transmission comb, including comb size, comb offset and cyclic shift. (2) Information related to time domain resource mapping including starting symbol within a slot, number of SRS symbols and repetition factor. (3) information related to frequency domain including freqDomainPosition N_RRC, freqDomainShift n_shift, and frequency hopping parameters c-SRS, b-SRS, and b-hop. (4) Information related to group or sequence hopping, whether one of them or neither is enabled. (5) for periodic and semi-persistent SRS, the periodicity and offset of the SRS resource. (6) Sequence ID. (7) Information related to the TCI state or spatial relation info.

In 5G NR, a UE can transmit a sounding reference signal (SRS). A SRS resource is configured by higher layer IE SRS-Resource.

The SRS sequence is a low peak-to-average power ratio (PAPR) sequence of length N_{ZC}=M_{sc,b}^{SRS} given by:

$${r}^{( p )} ( n , {l}^{′} ) = {r}_{u , v}^{( α , δ )} ( n ) = {e}^{j α n} {\overline{r}}_{u , v} ( n ) , 0 \leq n < {M}_{ZC}$$

where M_{ZC}=mN_{sc}^{RB}2^{δ}, δ=log (K_{TC}), with K_{TC} being the transmission comb number is provided in higher layer IE transmissionComb, K_{TC}∈{2,4,8}. l′ is the SRS symbol within a SRS resource of a slot, l′∈{0,1, . . . , N_{symb}^{SRS}−1}, N_{symb}^{SRS} is the number of SRS symbols in a slot. The cyclic shift αᵢ for antenna port pᵢ is given by

$${α}_{i} = 2 π \frac{{n}_{SRS}^{cs , i}}{{n}_{SRS}^{cs , ma x ,}} and {n}_{SRS}^{cs , i} = ( {n}_{SRS}^{cs} + \frac{{n}_{SRS}^{cs , m ax} ( {p}_{i} - 1000 )}{{N}_{a p}^{SRS}} ) mod {n}_{S R S}^{cs , m ax}$$

with n_{SRS}^{cs} being provided by higher layer in IE transmissionComb, n_{SRS}^{cs,max} depends on K_{TC} as illustrated in Table 2.

TABLE 2

| K_{TC} | n_{SRS}^{cs, max} |
|---|---|
| 2 | 8 |
| 4 | 12 |
| 8 | 6 |

u is the group number u∈{0, 1, . . . , 29}, v is the base sequence number, with v∈{0}, if 6≤N_{ZC}≤60 and ∈{0}, if 60<N_{ZC}. The base sequence, r̅_{u,v}(n), is generated as follows:
1. For N_{ZC}∈{6,12,18,24}, r̅_{u,v}(n)=e^{jϕ(n)π/4}, with 0≤n<M_{ZC}−1. ϕ(n) is given by Tables 5.2.2.2-1 to 5.2.2.2-4 of TS 38.211 [REF1].
2. For N_{ZC}=30,

$${\overline{r}}_{u , v} ( n ) = {e}^{- j \frac{π ( u + 1 ) ( n + 1 ) ( n + 2 )}{31}} ,$$

with 0≤n<M_{ZC}−1.
3. For N_{ZC}≥30, r̅_{u,v}(n)=x_{q} (n mod N_{ZC}),

$${x}_{q} ( n ) = {e}^{- j \frac{π qm ( m + 1 )}{{N}_{ZC}}} .$$

N_{ZC} is the largest prime number less than

$${M}_{ZC} \cdot q = ⌊ \overline{q} + 1 / 2 ⌋ + v \cdot {( - 1 )}^{⌊ 2 \overline{q} ⌋} \cdot \overline{q} = {N}_{ZC} \frac{u + 1}{31} .$$

The sequence group u is given by: u=(f_{gh}(n_{s,f}^{μ}, l′)+n_{ID}^{SRS}). Where, n_{ID}^{SRS} is provided by higher layer parameter sequenceID, with n_{ID}^{SRS}∈{0, 1, . . . , 65535}. Higher layer parameter groupOrSequenceHopping determines the values of u and v:
if groupOrSequenceHopping equals ‘neither’, neither group, nor sequence hopping shall be used and f_{gh}(n_{s,f}^{μ}, l′)=0, and v=0.
if groupOrSequenceHopping equals ‘groupHopping’, group hopping but not sequence hopping is used and v=0, and f_{gh}(n_{s,f}^{μ}, l′)=(Σₘ₌₀⁷c(8(n_{s,f}^{μ}N_{symb}^{slot}+l₀+l′)+m)·2^{m}) mod 30, N_{symb}^{slot} is the number of symbols in a slots, l₀ is the first SRS symbols in the slot, and c(n) a length-31 Gold sequence defined as c(n)=(x₁ (n+N_{c})+x₂ (n+N_{c}) mod 2, with N_{c}=1600, x₁ (n+31)=(x₁(n+3)+x₁(n))mod 2, x₂(n+31)=(x₂(n+3)+x₂(n+2)+x₂ (n+1)+x₂(n)) mod 2, the first m-sequence is initialized with x₁(0)=1, and x₁(n)=0, for n=1 . . . 30. The second m-sequence is initialized with cᵢₙᵢₜ, where cᵢₙᵢₜ=n_{ID}^{SRS}
if groupOrSequenceHopping equals ‘sequenceHopping’, sequence hopping but not group hopping is used and f_{gh}(n_{s,f}^{μ}, l′)=0 and

$$\\ v = \{ \begin{matrix}c ( {n}_{s , f}^{μ} {N}_{symb}^{slot} + {l}_{0} + {l}^{′} ) & {M}_{sc , b}^{S R S} \geq 6 {N}_{sc}^{R B} \\ 0 & otherwise\end{matrix}$$

N_{symb}^{slot} is the number of symbols in a slots, l₀ is the first SRS symbols in the slot, and c(n) a length-31 Gold sequence as previously defined.

The SRS sequence, r^{(p)}(n, l′), is mapped to resource elements a_{k,l}^{(p)} within a slot, where k is the sub-carrier frequency, l is the symbol number within the slot and p is the antenna port, where for SRS there is one antenna port, by

$${a}_{k , l}^{( p )} = {β}_{SRS} {r}^{( p )} ( {k}^{′} , {l}^{′} )$$

$$l = {l}^{′} + {l}_{0}$$

Where,
β_{SRS} is a scaling factor, k′=0, 1, . . . , M_{sc,b}^{SRS}=m_{SRS,b}N_{sc}^{RB}/K_{TC}, m_{SRS,b} is provided by Table 6.4.14.3-1 of TS 38.211 [REF1], and l′=0, 1, . . . , N_{symb}^{SRS}−1.
l=l′+l₀, with l₀ the first SRS symbols in the slot, where l₀∈{0, 1, . . . , 13}.
k=K_{TC}k′+k₀^{(p}^{ᵢ}⁾, K_{TC} is the transmission comb number as previously described, k₀^{(p)}=k̅₀^{(p)}+Σ_{b=0}^{B}^{_{SRS}}K_{TC}M_{sc,b}^{SRS}n_{b}, k̅₀^{(p}^{ᵢ}⁾=n_{shift}N_{sc}^{RB}+(k_{TC}^{(p}^{ᵢ}⁾+k_{offset}^{l′) mod K}_{TC},

$${k}_{TC}^{( {p}_{i} )} = \{ \begin{matrix}( {\overline{k}}_{TC} + {K}_{TC} / 2 ) mod {K}_{TC} & \begin{matrix}if {n}_{SRS}^{cs} ∈ \{ \frac{{n}_{SRS}^{cs , ma x}}{2} , … , {n}_{SRS}^{cs , m ax} - 1 \} \\ and {N}_{ap}^{SRS} = 4 and {p}_{i} ∈ \{ 1001 , 1003 \}\end{matrix} \\ {\overline{k}}_{TC} & otherwise\end{matrix}$$

k̅_{TC} is the transmission comb offset included within higher layer IE transmissionComb, with k̅_{TC}∈{0,1, . . . , K_{TC}−1}, k_{offset}^{l′} is a symbol dependent sub-carrier offset given by Table 3, n_{shift} is given by higher layer parameter freqDomainShift and it adjust the frequency allocation with respect to a reference point. If N_{BWP}^{start}≤n_{shift} the reference point for k₀^{(p)} is sub-carrier 0 in common resource block 0, otherwise the reference point is the lowest subcarrier of the BWP. n_{b} is a frequency positioning index. n_{b} is given by:

$${n}_{b} = ⌊ \frac{4 {n}_{RRC}}{{m}_{SRS , b}} ⌋ mod {N}_{b}$$

n_{RRC} is given by higher layer parameter freqDomainPosition, and m_{SRS,b} and N_{b} are determined by Table 6.4.14.3-1 of TS 38.211 [REF1] with b=B_{SRS} and the configured value of C_{SRS}.

TABLE 3

| | k_{offset}⁰, k_{offset}¹, . . . , | | | | |
|---|---|---|---|---|---|
| | k_{offset}^{N}^{_{symb}}^{^{SRS}}⁻¹ | | | | |
| K_{TC} | N_{symb}^{SRS} = 1 | N_{symb}^{SRS} = 2 | N_{symb}^{SRS} = 4 | N_{symb}^{SRS} = 8 | N_{symb}^{SRS} = 12 |
| 2 | 0 | 0, 1 | 0, 1, 0, 1 | — | — |
| 4 | — | 0, 2 | 0, 2, 1, 3 | 0, 2, 1, 3, | 0, 2, 1, 3, 0, 2, |
| | | | | 0, 2, 1, 3 | 1, 3, 0, 2, 1, 3 |
| 8 | — | — | 0, 4, 2, 6 | 0, 4, 2, 6, | 0, 4, 2, 6, 1, 5, |
| | | | | 1, 5, 3, 7 | 3, 7, 0, 4, 2, 6 |

In NR paging is used to alert idle and inactive UEs of incoming calls, messages and data. Paging is used to trigger RRC setup (e.g., RRC setup request or RRC connection resumption).

Paging is transmitted over the paging channel (PCH). The paging message includes a paging record list, which is a list of UEs being paged, each identified by a temporary mobile subscriber identity (TMSI) or an inactive Radio Network Temporary Identifier (I-RNTI). The 5G S-Temporary Mobile Subscription Identifier (5G-S-TMSI), a temporary UE identity provided by the 5GC which uniquely identifies the UE (e.g., the UE 116) within the tracking area. The I-RNTI is used to identify the suspended UE context of a UE in RRC_INACTIVE.

The following messages describe the contents of a paging message:

| | |
|---|---|
| PCCH-Message ::= | SEQUENCE { |
| message | PCCH-MessageType |

}

| | |
|---|---|
| PCCH-MessageType ::= | CHOICE { |
| c1 | CHOICE { |
| paging | Paging, |

```
    spare1 NULL
  },
```

| | |
|---|---|
| messageClassExtension | SEQUENCE { } |

}

| Paging ::= | SEQUENCE { | |
|---|---|---|
| pagingRecordList | PagingRecordList | OPTIONAL, -- |

Need N

| | | |
|---|---|---|
| lateNonCriticalExtension | OCTET STRING | OPTIONAL, |
| nonCriticalExtension | Paging-v1700-IEs | OPTIONAL |

}

| | |
|---|---|
| PagingRecordList ::= | SEQUENCE (SIZE(1..maxNrofPageRec)) OF PagingRecord |
| PagingRecord ::= | SEQUENCE { |
| ue-Identity | PagingUE-Identity, |
| accessType | ENUMERATED {non3GPP} OPTIONAL, -- Need N |

...
}

| | |
|---|---|
| PagingUE-Identity ::= | CHOICE { |
| ng-5G-S-TMSI | NG-5G-S-TMSI, |
| fullI-RNTI | I-RNTI-Value, |

...
}

| | |
|---|---|
| NG-5G-S-TMSI ::= | BIT STRING (SIZE (48)) |
| I-RNTI-Value ::= | BIT STRING (SIZE(40)) |

A UE may use Discontinuous Reception (DRX) in RRC_IDLE and RRC_INACTIVE state in order to reduce power consumption. The UE monitors one paging occasion (PO) per DRX cycle, T. Where, a PO is a set of PDCCH monitoring occasions and can include multiple time slots where paging DCI can be sent. A Paging Frame (PF) is one Radio Frame and may contain one or multiple PO(s) or starting point of a PO.

The PF and PO for paging are determined by the following equations:
single frequency network (SFN) of the PF is determined by: (SFN+PF_offset) mod T=(T div N)*(UE_ID mod N)
The index i_s of the PO is determined by: i_s=floor (UE_ID/N) mod Ns

### Where,

T is the DRX cycle of the UE, determined by the shortest of the UE specific DRX value(s) and a default DRX value included in SIB1. (1) For CN-initiated paging, a default cycle is broadcast in system information. (2) For CN-initiated paging, a UE specific cycle can be configured via non access stratum (NAS) signaling. (3) For RAN-initiated paging, a UE-specific cycle is configured via RRC signaling. A UE in RRC_IDLE uses the shortest of (1) and (2). A UE in RRC_INACTIVE uses the shortest of (1), (2) and (3).
N is a number of total paging frames in T, provided by nAndPagingFrameOffset in SIB1.
Ns is a number of paging occasions for a PF, provided by ns in SIB1
PF_offset is an offset used for PF determination, provided by nAndPagingFrameOffset in SIB1.
UE_ID: 5G-S-TMSI mod 1024

Embodiments of the present disclosure recognizes the need to minimize the probability of paging false alarms which occur when a UE decodes the PCH due to another UE assigned to the same PO being paged. UEs assigned to the same PO are divided in into sub-groups, a DCI carrying a paging early indication (PEI) is transmitted before the corresponding PO to indicate the sub-groups with paging messages in the PO. A UE that is not in the indicated sub-groups indicated by the PEI doesn't decode the corresponding PO. There can be up to 8 sub-groups. The subgroups can be CN controlled sub-groups (determined by the access and mobility function (AMF)), and/or UE-ID based sub-groups.

DCI format 2_7 is used for notifying the paging early indication and tracking reference signal (TRS) availability indication for one or more UEs. DCI Format 2_7 has a CRC scrambled by PEI RNTI. DCI Format 2_7 includes: (1) a paging indication field of size N_{PO}^{PEI}·N_{SG}^{PO}, where, N_{PO}^{PEI} is the number of paging occasions configured by higher layer parameter po-NumPerPEI, and N_{SG}^{PO} is the number of sub-groups of a paging occasion configured by higher layer parameter subgroupsNumPerPO. Each bit in the field indicates one UE subgroup of a paging occasion. (2) TRS availability indication, which can be of size 1-6 bits, where the number of bits is equal to one plus the highest value of the indBitID(s) provided by the trs-ResourceSetConfig if configured; 0 bits otherwise. Each TRS resource set is configured with an ID i for the association with (i+1)-th indication bit.

This disclosure provides early triggering of SRS for UEs in RRC_IDLE or RRC_INACTIVE states when the network has data to send to the UE or the UE has data send to network. Early SRS transmission can assist in determining the channel conditions and better link adaptation and better precoding for downlink and uplink transmissions. This disclosure provides physical layer mechanisms as well as higher layer mechanisms for the network to trigger SRS transmission. The triggering of SRS can be during or associated with paging, or the triggering of SRS can be during or associated with a random access procedure for RRC setup or RRC reconfiguration.

When a UE is in RRC_IDLE state or RRC_INACTIVE state, and data arrives at the network (e.g., the network 130) for the UE, or data arrives at the UE for the network, the UE through RRC setup procedure or RRC reconfiguration procedure transitions to the RRC_CONNECTED state. After transition to the RRC_CONNECTED state the network can trigger SRS transmission from the UE for channel quality estimation and the UE can start transmitting and receiving data. The SRS triggered can be wideband SRS or sub-band SRS, which would require several SRS transmission instances to provide an estimate of the channel quality of the full bandwidth. This process, i.e., the estimation of the channel quality, can take tens of milli-seconds, and even longer with sub-band SRS. Data transmission/reception can be delayed until the channel quality has been estimated using SRS, hence increasing latency. Alternatively, data transmission/reception can proceed in parallel with the SRS transmission and by the time the channel quality is estimated, the data (depending on the amount of data) has already or mostly been transmitted or received, hence rendering the channel quality estimation less useful while preceding transmissions/receptions from/to the UE are with reduced spectral efficiency due to the absence of a channel estimate at the gNB (e.g., the BS 102) for the UE.

Embodiments of the present disclosure recognizes that to mitigate this issue, it is beneficial to have the channel quality estimated in parallel with the RRC setup procedure, or RRC reconfiguration procedure such that when the UE is ready to transmit or receive data at the completion of the setup or reconfiguration procedures, the channel quality has already been estimated and link adaptation and precoding for uplink or downlink data is based on the estimated channel quality. Hence, there is a benefit for transmitting SRS in parallel with RRC setup procedure, or RRC reconfiguration procedure to reduce latency.

When the network initiates a communication session, the UE is first paged, and this is then followed by a random access (RA), or also referred to as RACH, procedure. When the UE initiates a communication session, a RACH procedure is used. This disclosure provides signalling and methods for triggering SRS during paging or associated with the paging procedure. In one example, SRS can be triggered before or after paging using a message separate from the paging message. In another example, SRS can be triggered within the paging message, or SRS can be triggered within a paging early indication (PEI) message. This disclosure also provides signalling and methods for triggering SRS during a RACH procedure or associated with a RACH procedure. In one example, SRS can be triggered using a message separate from the RACH procedure messages. In another example, SRS can be triggered using a RACH procedure message, e.g., SRS can be triggered within RACH msg2 (RAR), or RACH msg4 (e.g., PDSCH message for contention resolution, e.g., containing contention resolution identity) for type-1 random access procedure, or RACH msgB for type-2 random access procedure. SRS transmission can be separate from the RACH procedure messages or can be transmitted in conjunction with the RACH procedure messages.

The present disclosure relates to a 5G/NR and/or 6G communication system.

This disclosure provides aspects related to design of early triggering of SRS for UEs in RRC_IDLE and RRC_INACTIVE states. Various embodiments of the present disclosure include one or more of the following:
Triggering container of early SRS, including L1-based containers and higher layer-based (e.g., MAC CE or RRC) containers.
Timing of triggering of SRS in relation to paging and random access procedure.
Transmission of SRS in relation to RACH procedure transmissions.
Signaling and determination of SRS resource.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

In the following, both frequency division duplexing (FDD) and time division duplexing (TDD) are regarded as a duplex method for DL and UL signaling. In addition, full duplex (XDD) operation is possible, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

In this disclosure MAC CE signaling can be UE-specific e.g., to one UE or can be UE common (e.g., to a group of UEs or all UEs in a cell). MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., uplink control information (UCI) on PUCCH or PUSCH). L1 control signaling be UE-specific e.g., to one UE or can be UE common (e.g., to a group of UEs or all UEs in a cell).

In this disclosure, configuration can refer to configuration by semi-static signaling (e.g., RRC or SIB signaling). In one example, a configuration can be applicable to multiple transmission instances, until a new configuration is received and applied.

In this disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In this disclosure a list with N elements can be denoted as L(i), where i can take N values, and L(i) can correspond to the element or entry associated with index i. In one example, i can take N arbitrary values. In one example, i=0, 1, . . . , N−1. In one example, i=1, 2, . . . , N. In one example, i is an identity of an element in the list.

In the present disclosure, the term “activation” describes an operation wherein a UE receives and decodes first information provided by a first signal from the network (or gNB) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group of RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as TCI, TCI states, SpatialRelationInfo, target RS, reference RS, and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as non-zero power (NZP) CSI-RS and/or SSB) with the result of the measurement used for calculating a beam report (e.g., including at least one L1-RSRP/L1-signal-to-interference-plus-noise ratio (SINR) accompanied by at least one CSI-RS resource indicator or SSB resource indicator). As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE, for example in case of channel reciprocity.

In this disclosure, DCI Format is used for L1 control information in the DL direction from gNB to UE. DCI Format (i.e., L1 control information) can be signal stage/part control information or two stage/part control information. In one example, the DCI format can be carried on a physical downlink control channel (PDCCH). In one example, DCI format can be carried on a physical downlink shared channel (PDSCH). In one example, DCI can be split between PDCCH (e.g., for a first part) and PDSCH (e.g. for a second part).

In this disclosure, a higher layer message (e.g., SIB-based or RRC-based or MAC CE-based) can be carried by a physical downlink shared channel (PDSCH). In one example, the PDSCH can be scheduled by a DCI format.

In one example, the configuration of early SRS resources can be configured or updated, by RRC signaling and/or MAC CE signaling and/or L1 control signaling.

In one example, the configuration of the SRS resource can include:
SRS resource ID
Time and frequency resources (e.g., symbols within a slot for SRS, starting symbol for SRS, number of repetitions, time slot for SRS, periodicity and offset of SRS (e.g., in case of periodic or semi-persistent SRS), starting PRB for SRS, number of PRBs for SRS, whether frequency hopping is enabled and if enabled frequency hopping pattern, etc.).
Number of instances, K, of SRS transmitted when SRS is triggered.
Comb size, comb offset and cycle shift.
Sequence for reference signal.
Power for reference signal.

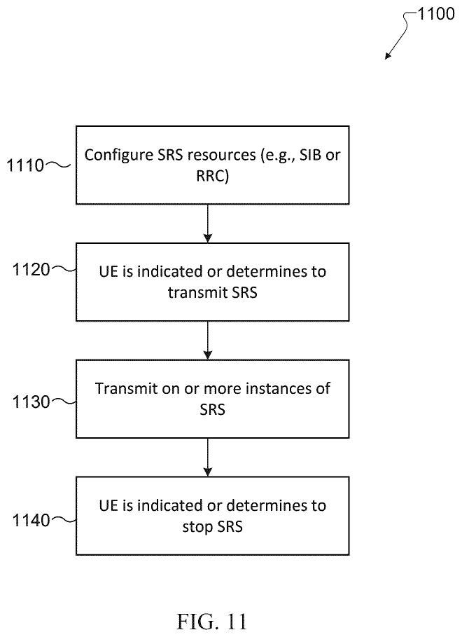

FIG. 11 illustrates a flowchart of an example UE procedure 1100 for transmitting SRS according to embodiments of the present disclosure. For example, procedure 1100 for transmitting SRS can be performed by any of the UEs 111-116 of FIG. 1. This example is for illustration only and other embodiments can be used without departing from the scope of the present disclosure.

The procedure begins in 1110, a UE can be configured with SRS resources and/or SRS resource sets by system information (e.g., system information block (SIB), e.g., SIB1 or other SIB) or by RRC configuration. In 1120, the UE can be indicated or determines to transmit SRS. In one example, the indication/determination can be by a message associated with paging. In one example, the indication/determination can be by a message associated with a random access (e.g., RACH) procedure. In one example, the indication can be by a message for triggering SRS transmission. In 1130, the UE, based on the indication or determination of SRS transmission, and the configured SRS resources, transmits SRS in one or more SRS transmission instances. In one example, the transmission is one-shot (e.g., one SRS transmission instance, or one SRS transmission instance per subband). In one example, the transmission is N-shot (e.g., N SRS transmission instances, or N SRS transmission instances per subband). In one example, the transmission is periodic. In one example, a UE can optionally determine or is indicated to stop SRS transmission (for example in case of periodic SRS transmission, or in case of N-shot SRS transmission). In 1140, the UE is indicated or determines to stop SRS.

In the examples, of this disclosure, the gNB or network sends a message to a UE (or to a group of UEs), and the message triggers a transmission of a SRS resource. In one example, the UE transmitting the SRS can be intended receiver of the message, for example this can be a random access response (RAR) to the UE that transmitted the preamble, or a MsgB to the UE that transmitted a MsgA for a type-2 random access procedure, or a contention resolution message or Msg4 to a UE that transmitted Msg3 of the random access procedure, or a message triggering SRS transmission. In one example, the UE transmitting the SRS can be a UE being paged, e.g., as determined by a paging early indication (PEI) and/or a paging occasion (PO). In one example, the UE identification is included in the message triggering the SRS transmission. In one example, the UE is determined as described in this disclosure.

In one example, resources used for SRS transmission, can be one of a set or group of resources configured by the network, e.g., by system information (e.g., SIB1 or other SIB) or RRC configuration. The SRS resource ID can be indicated or determined as described in this disclosure. In one example, when an SRS resource ID is indicated or determined, a subset of SRS resources is determined as described in this disclosure and a resource within the subset is indicated as described in this disclosure. In one example, when an SRS resource ID is indicated or determined, a subset of SRS resources is indicated as described in this disclosure and a resource within the subset is determined as described in this disclosure.

In one example, the configuration of the SRS resource parameters or a subset of the SRS resource parameters can be indicated to the UE in the message triggering the SRS transmission.

In one example, the time (slot/symbols) of the SRS transmission (e.g., the first instance of the SRS transmission) can be relative to the message or channel from the network triggering the SRS transmission. In one example, the time of the SRS transmission (e.g., the first instance of the SRS transmission) can be relative to a channel carrying a message related to paging procedure (e.g., channel carrying paging early indication (PEI) or channel scheduling or carrying paging message). In one example, the time of the SRS transmission (e.g., the first instance of the SRS transmission) can be relative to a message or channel of the random access procedure. In one example, the time of the SRS transmission can be included in the information triggering the SRS transmission.

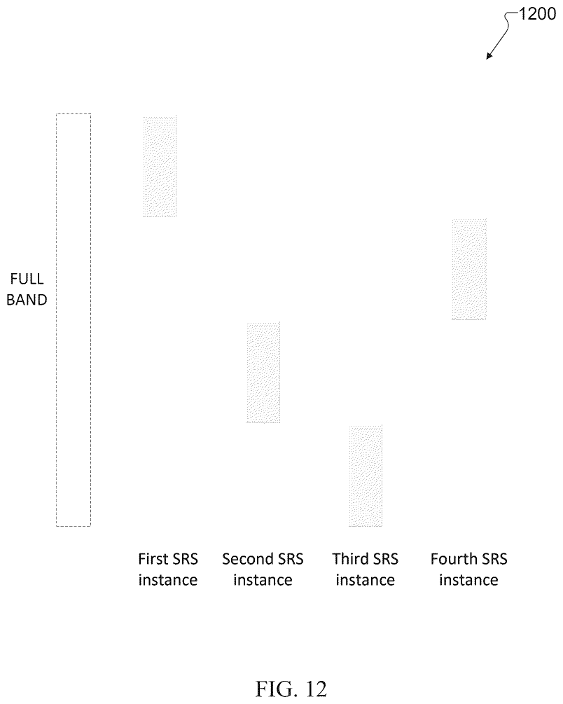

FIG. 12 illustrates a diagram of example subbands 1200 within a full band according to embodiments of the present disclosure. For example, subbands 1200 can be a SRS as described herein. This example is for illustration only and other embodiments can be used without departing from the scope of the present disclosure.

In one example, an SRS transmission triggered as described in this disclosure can be one of:
A single instance SRS transmission. In one example, the single transmission instance is for the SRS resource. In one example, the single transmission instance is per sub-band of SRS.
K instances of SRS transmissions. Wherein, K can be defined in the system specifications and/or configured or updated by system information and/or RRC signaling and/or MAC CE signaling and/or L1 control signaling. In one example, K can be indicated in the message triggering the SRS transmission. In one example, the K transmission instances are for the SRS resource (e.g., these can be over a wideband or multiple sub-bands). In one example, the K transmission instances are per sub-band of SRS (e.g., each sub-band of SRS is transmitted in K transmission instances). Optionally, the UE can be indicated or determines to early terminate SRS transmissions.
A periodical or semi-persistent transmission until a reconfiguration message or deactivation message is transmitted to the UE, e.g., to stop the SRS transmission.

In one example, SRS is sub-band SRS. The number of sub-bands within the full band is N. In one example, SRS is transmitted K times when triggered. In one example K=N, In one example, K>=N. In one example, a hopping pattern is used to sweep the SRS transmission in the different sub-bands, as illustrated in FIG. 12.

With reference to FIG. 12, an example is shown with 4 sub-bands in the full band (i.e., N=4). SRS is transmitted in 4 different SRS instances at different frequency locations to estimate the quality of the channel in the full band.

In one example, the SRS is triggered by a DCI format.

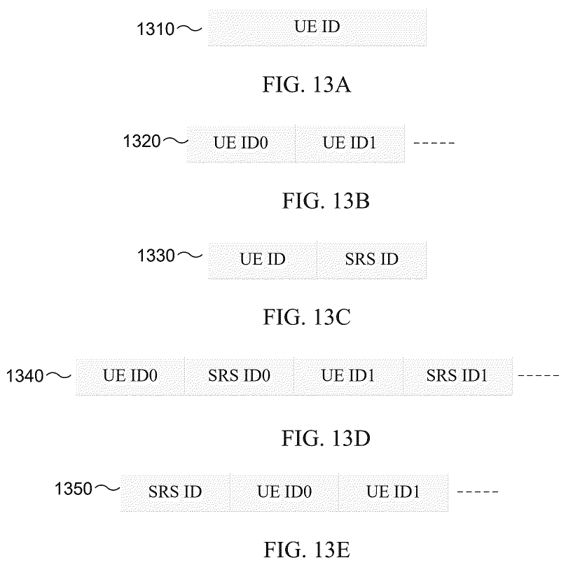

FIGS. 13A, 13B, 13C, 13D, and 13E illustrate diagrams of example SRS transmission triggers 1310, 1320, 1330, 1340, and 1350, respectively, according to embodiments of the present disclosure. For example, SRS transmission triggers 1310, 1320, 1330, 1340, and 1350, respectively, can trigger any of the UEs 111-116 of FIG. 1 for SRS transmission. This example is for illustration only and other embodiments can be used without departing from the scope of the present disclosure.

In one example, the DCI format includes a UE ID. In one example, the UE ID is a UE ID assigned or allocated by the core network, for example S-Temporary Mobile Subscription Identifier (S-TMSI or NG 5G S-TMSI). In one example, the UE ID is part of (or related to) the UE ID assigned by the core network, e.g. indicted UE ID is the n least significant bits of the UE ID, or indicted UE ID is the n most significant bits of the UE ID, or indicated ID is UE ID % N, or indicated ID is ceiling (UE ID/N). Where, % is the modulus function, where x % y is the remainder of dividing x by y. In one example, the UE ID is a UE ID assigned or allocated by the radio access network (RAN). In one example, UE ID is the I-RNTI. In one example, the UE-ID is a short I-RNTI (e.g., 24 bits of the I-RNTI). In one example, the UE ID is a long I-RNTI (e.g., 40 bits I-RNTI). In one example, the UE ID is part of (or related to) the UE ID assigned by the RAN, e.g. indicted UE ID is the n least significant bits of the UE ID, or indicted UE ID is the n most significant bits of the UE ID, or indicated ID is UE ID % N, or indicated ID is ceiling (UE ID/N).

FIGS. 13A, 13B, 13C, and 13D illustrate examples of fields related to a UE ID and SRS resource ID in a message triggering SRS transmission. The message can be a DCI Format and/or a higher layer message as described in this disclosure. Other fields are not excluded from the message of FIG. 13.

In one example, DCI Format includes 1 UE ID, for example as illustrated in FIG. 13A and FIG. 13C, wherein a UE-ID is as mentioned herein. In one example, DCI format includes N UE-IDs, for example as illustrated in FIG. 13B, FIG. 13D and FIG. 13E, wherein a UE-ID is as mentioned herein. In one example, N is defined in the system specifications, e.g., N=2 or N=3 or N=4, . . . . In one example, N is configured to the UE, for example, N can be in the system information e.g. SIB1 or other SIB or configured by RRC signaling and/or MAC CE signaling and/or L1 control signaling. In one example, the DCI Format is a two-stage or two-part DCI Format, the first stage or part includes the number N of UE IDs and the N UE IDs are included in the second stage or part.

In one example, SRS resource is configured by system information. In one example, M SRS resources are configured by system information (e.g., SIB1 or other SIB), wherein a UE (e.g., the UE 116) can determine the SRS resources to use when triggered to transmit SRS (e.g., by indication in the DCI Format). In one example, M SRS resources are configured by system information (e.g., SIB1 or other SIB), wherein a UE can determine the SRS resource to use when triggered to transmit SRS. In one example, SRS resource ID is included in the configuration of the SRS resource. In one example, the SRS resource ID is determined based on the order of the SRS resource in the list of M SRS resources. For a first SRS resource in the list has SRS resource ID 0 or SRS resource ID 1. A second SRS resource in the list has SRS resource ID 1 or SRS resource ID 2 respectively.

In one example, a SRS resource determination can be based on a mapping between UE-ID and the M configured SRS resources. In one example, a SRS resource determination can be based on a mapping between the resources used for the PDCCH reception providing the DCI Format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the M configured SRS resources. In one example, a SRS resource determination can be based on a mapping between UE-ID and resources used for PDCCH reception providing the DCI Format as mentioned herein, and the M configured SRS resources.

In one example, the DCI format includes a SRS resource ID as illustrated in FIG. 13C, FIG. 13D and FIG. 13E. In one example, a SRS resource ID is included for each UE ID for example as illustrated in FIG. 13C and FIG. 13D, wherein UE ID0 triggers SRS ID0, UE ID1 triggers SRS ID1, etc. In a variant example, DCI Format includes one SRS ID as illustrated in FIG. 13E. In one example of FIG. 13E, the SRS ID is for the UE ID0, the SRS ID for another UE ID can be determined based on the SRS ID and a rule, for example, UE ID1 can use SRS ID+1, UE ID2 can use SRS ID+2, etc. The rule can be a function of the SRS ID and the UE ID.

In one example, the CRC of the DCI Format is scrambled with a RNTI and the RNTI is associated with triggering SRS.

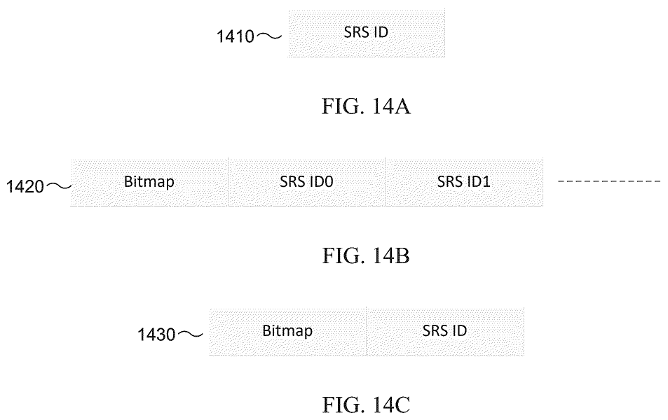

FIGS. 14A, 14B, and 14C illustrate diagrams of example SRS transmission identifiers 1410, 1420, and 1430, respectively, according to embodiments of the present disclosure. For example, SRS transmission identifiers 1410, 1420, and 1430, respectively, can be received by any of the UEs 111-116 of FIG. 1. This example is for illustration only and other embodiments can be used without departing from the scope of the present disclosure.

In one example, the DCI Format indicates the UE to trigger the SRS transmission. In one example, the DCI Format includes a bitmap, and there is mapping between a bit in the bitmap and the UE. In one example, this mapping is based on rule (e.g., derived based on the UE ID). In one example, this mapping is based on a network configuration. In one example, this mapping is based on a combination of a rule and network configuration. In one example, a UE is configured with a bit in the bitmap that corresponds to the UE.

In one example, the DCI Format indicated to the UE to trigger the SRS transmissions based on the time and/or frequency resources of the PDCCH providing the DCI Format, e.g., (e.g., starting) channel control elements (CCEs) or (e.g., starting) resource element groups (REGs) or (e.g., starting) resource blocks (RBs) or (e.g., starting) symbols or slots or subframes or frames, etc. In one example, this mapping is based on rule (e.g., derived based on the UE ID). In one example, this mapping is based on a network configuration. In one example, this mapping is based on a combination of a rule and network configuration. In one example, a UE is configured with the time and frequency resources of the DCI Format that correspond to the UE.

In one example, the DCI Format indicates to the UE to trigger the SRS transmissions based on the RNTI used to scramble the CRC of the DCI format. In one example, multiple RNTIs are configured for a DCI format triggering SRS. In one example, this mapping between RNTI and UE is based on a rule (e.g., derived based on the UE ID). In one example, this mapping between RNTI and UE is based on a network configuration. In one example, this mapping between RNTI and UE is based on a combination of a rule and network configuration. In one example, a UE is configured with a RNTI for SRS triggering that corresponds to the UE.

In one example, the DCI Format indicates to the UE to trigger the SRS based on one or more of bitmap and time/frequency resource for the PDCCH providing the DCI format and the RNTI for DCI Format as mentioned herein.

In one example, the DCI Format triggering SRS transmission indicates to the UE to transmit the SRS transmission, and the SRS ID is determined. In one example, a determination can be based on a mapping between UE-ID and the M configured SRS resources. In one example, a determination can be based on a mapping between the resources used for the PDCCH providing the DCI Format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the M configured SRS resources. In one example, a determination can be based on a mapping between UE-ID and resources used for reception of the PDCCH providing the DCI Format as mentioned herein, and the M configured SRS resources.

In one example, the DCI Format indicates to the UE to trigger the SRS transmission, and the SRS ID is indicated by information in the DCI Format for example as illustrated in FIG. 14A, FIG. 14B and FIG. 14C.

In one example, in FIG. 14A the ID to transmit SRS is indicated to the UE e.g., by the DCI Format (e.g., based on time and/or frequency resources a PDCCH providing the of DCI Format and/or RNTI of the DCI Format), and SRS ID of one of the M configured SRS resources is included in the DCI Format.

In one example, in FIG. 14B the UE(s) is indicated to transmit SRS by a bit map in a DCI Format and optionally based on time and/or frequency resources of a PDCCH providing the DCI Format and/or the RNTI of the DCI Format SRS ID(s) of one or more of the M configured SRS resources are included in the DCI Format. For example, the first SRS ID corresponds to the first non-zero bit of the bitmap, the second SRS ID corresponds to the second non-zero bit of the bitmap, and so on. The number of SRS IDs included in the DCI format can be equal to the number of non-zero bits in the bitmap. In one example, padding is included to make the size of the DCI Format constant and independent of the number of non-zero bits in the bitmap. In one example, the DCI format is a two stage or two-part DCI format, in one example, the bitmap is included in the first stage or part, and the SRS resource IDs corresponding to non-zero bits of the bitmap are included in the second stage or part.

In one example, in FIG. 14C the UE(s) is indicated to transmit SRS by a bit map in a DCI Format and optionally based on time and/or frequency resources of a PDCCH providing the DCI Format and/or the RNTI of the DCI Format SRS ID(s) of one or more of the M configured SRS resources are included in the DCI Format. A SRS resource ID is included in the message, and the resource ID for each UE transmitting SRS can be determined based on the order of corresponding non-zero bits and the SRS ID. For example, the UE corresponding to the first non-zero bit transmits SRS resource with SRS ID, the UE corresponding to the second non-zero bit transmits SRS resource with SRS ID+1, and so on. The rule can be a function of the SRS ID and the non-zero-bit position relative to other non-zero bits or in the bitmap.

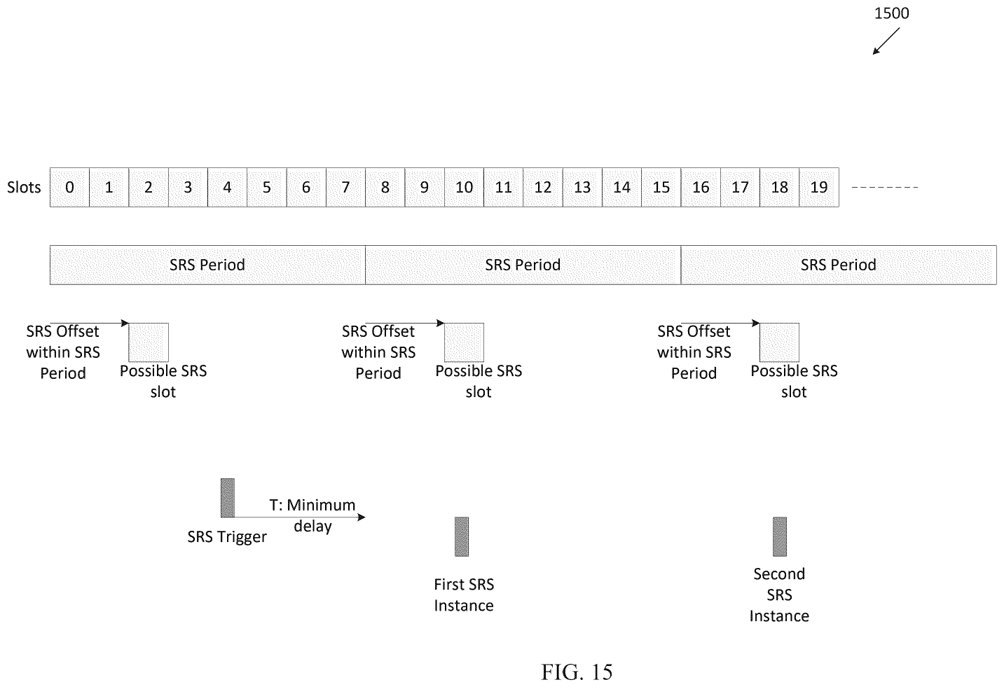

FIG. 15 illustrates a diagram of an example SRS resource configuration 1500 according to embodiments of the present disclosure. For example, SRS configuration 1500 can be received by the UE 116 of FIG. 3. This example is for illustration only and other embodiments can be used without departing from the scope of the present disclosure.

In one example, the slot or subframe or frame used by a UE to transmit SRS resource can be based on configuration of the corresponding SRS (e.g., using system information, e.g., SIB1 or other SIB).

In one example, the SRS resource can be transmitted by a UE a minimum time T from the end (or start) of a PDCCH reception providing the DCI Format triggering the SRS transmission or the start of end of the channel (e.g., PUCCH or PUSCH) carrying the acknowledgment to the DCI format. In one example, the slot or subframe or frame used by a UE to transmit SRS resource can be at or after a time T from the end (or start) of the PDCCH reception providing the DCI Format triggering the SRS transmission or at or after a time T from the end (or start) of the channel (e.g., PUCCH or PUSCH) carrying the acknowledgment to the DCI format. In one example, the slot or subframe or frame used by a UE to transmit SRS resource is that first slot or subframe or frame that starts at or after a time T from the end (or start) of a PDCCH reception providing the DCI Format triggering the SRS transmission and optionally based on an offset and a periodicity as illustrated in FIG. 15. In one example, the slot or subframe or frame used by a UE to transmit SRS resource is that first slot or subframe or frame that starts at or after a time T from the end (or start) of the channel (e.g., PUCCH or PUSCH) carrying the acknowledgment to the DCI format triggering the SRS transmission and optionally based on an offset and a periodicity as illustrated in FIG. 15. Wherein, the time T can be defined in the system specifications and/or configured or updated by network (e.g., the network 130) (e.g., using SIB signaling (SIB1 or other SIB) and/or RRC signaling and/or MAC CE signaling and/or L1 control signaling).

In one example, there is no acknowledgment information for the DCI Format triggering the SRS, and the transmission of SRS can be regarded as an acknowledgment information. For example, if the network doesn't receive or detect SRS, the DCI Format can be retransmitted.

With reference to FIG. 15, an example of SRS configuration is shown, where a SRS period is configured (e.g., 8 slots) and a SRS offset within the SRS period for the SRS slots is configured (e.g., 2 slots). The configuration of the SRS offset and SRS period can be by SIB configuration or by RRC configuration. The SRS period and the SRS offset determine the SRS slots. A UE receives a SRS trigger, after a delay T from the SRS trigger the SRS can be transmitted. The UE transmits the first instance of SRS in the earliest (first) SRS slot (as determined by the period and offset) occurring after a time T from the SRS trigger or the acknowledgment to the SRS trigger as illustrated in FIG. 15. In FIG. 15, SRS is transmitted in two instances.

In one example, the SRS is triggered by a message (e.g., higher layer message) in a PDSCH.

In one example, this message is a SIB message. In one example, this message is a RRC message. In one example, this message is a MAC CE message. In one example, the PDSCH providing the message is scheduled by a corresponding DCI Format.

In one example, the higher layer message includes a UE ID. In one example, the UE ID is a UE ID assigned or allocated by the core network, for example S-Temporary Mobile Subscription Identifier (S-TMSI or NG 5G S-TMSI). In one example, the UE ID is part of (or related to) the UE ID assigned by the core network, e.g. indicted UE ID is the n least significant bits of the UE ID, or indicted UE ID is the n most significant bits of the UE ID, or indicated ID is UE ID % N, or indicated ID is ceiling (UE ID/N). Where, % is the modulus function, where x % y is the remainder of dividing x by y. In one example, the UE ID is a UE ID assigned or allocated by the radio access network (RAN). In one example, UE ID is the I-RNTI. In one example, the UE-ID is a short I-RNTI (e.g., 24 bits of the I-RNTI). In one example, the UE ID is a long I-RNTI (e.g., 40 bits I-RNTI). In one example, the UE ID is part of (or related to) the UE ID assigned by the RAN, e.g. indicted UE ID is the n least significant bits of the UE ID, or indicted UE ID is the n most significant bits of the UE ID, or indicated ID is UE ID % N, or indicated ID is ceiling (UE ID/N).

In one example, the higher layer message includes 1 UE ID, for example as illustrated in FIG. 13(A) and FIG. 13(C), wherein a UE-ID is as mentioned herein. In a variant example, the signaling of the UE ID is split between the DCI Format and the higher layer message. In one example, the higher layer message includes N UE-IDs, for example as illustrated in FIG. 13(B), FIG. 13(D) and FIG. 13(E), wherein a UE-ID is as mentioned herein. In one example, N is defined in the system specifications, e.g., N=2 or N=3 or N=4, . . . . In one example, N is configured to the UE, for example, N can be in the system information e.g. SIB1 or other SIB or configured by RRC signaling and/or MAC CE signaling and/or L1 control signaling. In a variant example, the signaling of the N UE IDs is split between the DCI Format and the higher layer message. In one example, the DCI format includes one part of the UE ID for each of the N UE IDs, and the higher layer message includes a second part for each of the N UE IDs. In one example, the DCI format includes one part of the UE ID that is common for the N UE IDs, and the higher layer message includes a second part for each of the N UE IDs. In one example, the DCI Format includes the number N of UE IDs and the N UE IDs are included the message scheduled by the DCI Format.

In one example, SRS resource is configured by system information. In one example, M SRS resources are configured by system information (e.g., SIB1 or other SIB), wherein a UE can determine the SRS resources to use when triggered to transmit SRS (e.g., by indication in the DCI Format). In one example, M SRS resources are configured by system information (e.g., SIB1 or other SIB), wherein a UE can determine the SRS resources to use when triggered to transmit SRS. In one example, SRS resource ID is included in the configuration of the SRS resource. In one example, the SRS resource ID is determined based on the order of the SRS resource in the list of M SRS resources. For a first SRS resource in the list has SRS resource ID 0 or SRS resource ID 1. A second SRS resource in the list has SRS resource ID 1 or SRS resource ID 2 respectively.

In one example, a SRS resource determination can be based on a mapping between UE-ID and the M configured SRS resources. In one example, a SRS resource determination can be based on a mapping between the resources used for the higher layer message and/or the PDCCH providing the corresponding DCI Format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the M configured SRS resources. In one example, a SRS resource determination can be based on a mapping between UE-ID and resources used for higher layer message and/or the PDCCH providing the corresponding DCI Format as mentioned herein, and the M configured SRS resources.

In one example, the higher layer message and/or the corresponding DCI Format includes a SRS resource ID as illustrated in FIG. 13(C), FIG. 13(D) and FIG. 13(E). In one example, a SRS resource ID is included for each UE ID for example as illustrated in FIG. 13(C) and FIG. 13(D), wherein UE ID0 triggers SRS ID0, UE ID1 triggers SRS ID1, etc. In a variant example, higher layer message and/or the corresponding DCI Format includes one SRS ID as illustrated in FIG. 13(E). In one example of FIG. 13(E), the SRS ID is for the UE ID0, the SRS ID for another UE ID can be determined based on the SRS ID and a rule, for example, UE ID1 can use SRS ID+1, UE ID2 can use SRS ID+2, etc. The rule can be a function of the SRS ID and the UE ID.

In one example, the CRC of the higher layer message and/or the corresponding DCI Format is scrambled with a RNTI and the RNTI is associated with triggering SRS.

In one example, the higher layer message and/or the corresponding DCI Format indicates to the UE to trigger the SRS transmission. In one example, the higher layer message and/or the corresponding DCI Format includes a bitmap, and there is mapping between a bit in the bitmap and the UE. In one example, this mapping is based on rule (e.g., derived based on the UE ID). In one example, this mapping is based on a network configuration. In one example, this mapping is based on a combination of a rule and network configuration. In one example, a UE is configured with a bit in the bitmap that corresponds to the UE.

In one example, the higher layer message and/or the corresponding DCI Format indicates to the UE to trigger the SRS transmission based on the time and/or frequency resources of the PDCCH providing the DCI Format, e.g., (e.g., starting) channel control elements (CCEs) or (e.g., starting) resource element groups (REGs) or (e.g., starting) resource blocks (RBs) or (e.g., starting) symbols or slots or subframes or frames, etc. In one example, this mapping is based on rule (e.g., derived based on the UE ID). In one example, this mapping is based on a network configuration. In one example, this mapping is based on a combination of a rule and network configuration. In one example, a UE is configured with the time and frequency resources of the higher layer message and/or the corresponding DCI Format that correspond to the UE.

In one example, the higher layer message and/or the corresponding DCI Format indicates to the UE to trigger the SRS transmission based on the RNTI used to scramble the CRC of the DCI format. In one example, multiple RNTIs are configured for a DCI format triggering SRS and/or a higher layer message. In one example, this mapping between RNTI and UE is based on a rule (e.g., derived based on the UE ID). In one example, this mapping between RNTI and UE is based on a network configuration. In one example, this mapping between RNTI and UE is based on a combination of a rule and network configuration. In one example, a UE is configured with a RNTI for SRS triggering that corresponds to the UE.

In one example, the higher layer message and/or the PDCCH providing the corresponding DCI Format indicates to the UE to trigger the SRS transmission based on one or more of bitmap and time/frequency resource for higher layer message and/or the PDCCH providing the corresponding DCI format and the RNTI for higher layer message and/or the corresponding DCI Format as mentioned herein.

In one example, the higher layer message and/or the corresponding DCI Format triggering SRS transmission indicates to the UE to transmit the SRS transmission, and the SRS ID is determined from other parameters. In one example, the determination can be based on a mapping between UE-ID and the M configured SRS resources. In one example, the determination can be based on a mapping between the resources used for the higher layer message and/or the corresponding PDCCH that provides the DCI Format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the M configured SRS resources. In one example, the indication can be based on a mapping between UE-ID and resources used for the PDCCH providing the DCI Format as mentioned herein, and the M configured SRS resources.

In one example, the higher layer message and/or the corresponding PDCCH/DCI Format indicates to the UE to trigger the SRS transmission, and the SRS ID is indicated in the higher layer message and/or the corresponding PDCCH/DCI Format for example as illustrated in FIG. 14A, FIG. 14B and FIG. 14C.

In one example, in FIG. 14A the UE is indicated to transmit SRS by the higher layer message and/or the corresponding PDCCH/DCI Format (e.g., based on time and/or frequency resources of higher layer message and/or the corresponding PDCCH/DCI Format and/or RNTI of higher layer message and/or the corresponding DCI Format), and SRS ID of one of the M configured SRS resources is included in the higher layer message and/or the corresponding DCI Format.

In one example, in FIG. 14B the UE(s) to transmit SRS are determined by bit map in the higher layer message and/or the corresponding DCI Format and optionally based on time and/or frequency resources of higher layer message and/or the corresponding PDCCH/DCI Format and/or RNTI of higher layer message and/or the corresponding DCI Format, and SRS ID(s) of one or more of the M configured SRS resources are included in the higher layer message and/or the corresponding DCI Format. For example, the first SRS ID corresponds to the first non-zero bit of the bitmap, the second SRS ID corresponds to the second non-zero bit of the bitmap, and so on. The number of SRS IDs included in higher layer message and/or the corresponding DCI Format can equal to the number of non-zero bits in the bitmap. In one example, padding is included to make the size of the DCI Format associated with the higher layer message constant and independent of the number of non-zero bits in the bitmap. In one example, the DCI format is a two stage or two-part DCI format, in one example, the bitmap is included in the first stage or part, and the SRS resource IDs corresponding to non-zero bits of the bitmap are included in the second stage or part and/or the higher layer message.

In one example, in FIG. 14C the UE(s) to transmit SRS are determined by bit map in the higher layer message and/or the corresponding DCI Format and optionally based on time and/or frequency resources of higher layer message and/or the corresponding PDCCH/DCI Format and/or RNTI of higher layer message and/or the corresponding DCI Format, and SRS ID(s) of one or more of the M configured SRS resources are included in the higher layer message and/or the corresponding DCI Format. A SRS resource ID is included in the bit map, the resource ID for each UE transmitting SRS can be determined based on the order of corresponding non-zero bit and the SRS ID. For example, the UE corresponding to the first non-zero bit transmits SRS resource with SRS ID, the UE corresponding to the second non-zero bit transmits SRS resource with SRS ID+1, and so on. The rule can be a function of the SRS ID and the non-zero-bit position relative to other non-zero bits or in the bitmap.

In one example, the slot or subframe or frame used by a UE to transmit SRS resource can be based on configuration of the corresponding SRS (e.g., using system information, e.g., SIB1 or other SIB).

In one example, the SRS resource can be transmitted at or after a time T from the end (or start) of a PDSCH reception providing the higher layer message or from the end (or start) of the PDCCH reception providing the corresponding DCI Format triggering the SRS transmission or the start of end of the channel (e.g., PUCCH or PUSCH) carrying the acknowledgment to the PDSCH. In one example, the slot or subframe or frame used to transmit SRS resource can be at least a time T after the end (or start) of the PDSCH reception providing the higher layer message or of the PDCCH reception providing the corresponding DCI Format triggering the SRS transmission or at or after a time T from the end (or start) of the channel (e.g., PUCCH or PUSCH) carrying the acknowledgment to the PDSCH. In one example, the slot or subframe or frame used to transmit SRS resource is that first slot or subframe or frame that starts after a time T from the end (or start) of the PDSCH reception providing the higher layer message or from the end (or start) of the PDCCH reception providing the corresponding DCI Format triggering the SRS transmission and optionally based on an offset and a periodicity as illustrated in FIG. 15. In one example, the slot or subframe or frame used by a UE to transmit SRS resource is that first slot or subframe or frame that starts at or after a time T from the end (or start) of the channel (e.g., PUCCH or PUSCH) carrying the acknowledgment to the PDSCH reception providing the higher layer message triggering the SRS transmission and optionally based on an offset and a periodicity as illustrated in FIG. 15 Wherein, the time T can be defined in the system specifications and/or configured or updated by network (e.g., using SIB signaling (SIB or other SIB) and/or RRC signaling and/or MAC CE signaling and/or L1 control signaling).

In one example, the SRS resource can be transmitted at or after a time T after an end (or start) of a PUCCH or PUSCH transmission with acknowledgment information corresponding to the higher layer message triggering the SRS transmission. In one example, the slot or subframe or frame used to transmit SRS resource can be at or after a time T after the end (or start) of a PUCCH or PUSCH transmission with an acknowledgment information corresponding to the higher layer message triggering the SRS transmission. In one example, the slot or subframe or frame used to transmit SRS resource is that first slot or subframe or frame that starts at or after a time T after the end (or start) of a PUCCH or PUSCH transmission with an acknowledgment information corresponding to the higher layer message triggering the SRS transmission and optionally based on an offset and a periodicity as illustrated in FIG. 15, where the SRS trigger is replaced by acknowledgment to SRS trigger. Wherein, the time T can be defined in the system specifications and/or configured or updated by network (e.g., using SIB signaling (SIB1 or other SIB) and/or RRC signaling and/or MAC CE signaling and/or L1 control signaling).

In one example, there is no acknowledgment information for the higher layer message, and the transmission of SRS can be regarded as an acknowledgment information. For example, if the network doesn't receive or detect SRS, the higher layer message can be retransmitted.

In a variant of the mentioned herein examples, the SRS configuration parameters (or a subset of them) for one or more SRS resources can be included in the higher layer message and/or the corresponding DCI format instead of or in addition to the SRS ID for the one or more SRS resources. Wherein the configuration for the SRS resource can be as mentioned herein.

In one example, associated with a paging occasion is a paging early indication (PEI). Wherein, the PEI includes an indication for each subgroup of a PO whether there is a corresponding paging message for the UEs of that subgroup. In one example, the PEI is conveyed using a DCI Format (e.g., DCI Format 2_7 in NR).

In one example, associated with each subgroup of UEs for a PO is a bit indicating whether SRS is triggered or transmitted by the paged UEs of that subgroup.

In one example, associated with subgroups of UEs for a PO is a bit indicating whether SRS is triggered or transmitted by the paged UEs of that PO.

In one example, associated with the POs of a PEI is a bit indicating whether SRS is triggered or transmitted by the paged UEs of the POs of the PEI.

In one example, the UE(s) transmitting the SRS is determined based on the paged UE(s) in the corresponding PO.

In one example, M SRS resources are configured by system information (e.g., SIB1 or other SIB). In one example, the SRS resource ID transmitted by a UE is determined based on one or more of the following:
The UE transmitting the SRS
The subgroup ID
The PO
The resources used for the reception of the PDCCH providing the DCI Format of the PEI (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.)
The order of the paged UE in the PO or in a subgroup of the PO

In one example, this mapping between the SRS resource ID and the mentioned herein parameters is based on a rule. In one example, this mapping between the SRS resource ID and the mentioned herein parameters is based on a network configuration. In one example, this mapping between the SRS resource ID and the mentioned herein parameters is based on a combination of a rule and network configuration.

In one example, the SRS resource ID transmitted by a UE (e.g., the UE 116) is determined based on one or more of the following:
A bitmap(s) included in the PEI. In one example, there is a one-to-one mapping between the bits of the bitmap and the M SRS resources configured by system information (e.g., SIB1 or other SIB). In one example, one bitmap is included in PEI for UEs that are being paged by the POs corresponding to the PEI. In one example, a bitmap is included in PEI for each PO in the PEI. In one example, a bitmap is included in PEI for each subgroup of a PO in the PEI. In one example, if a bit in the bitmap is “1” the corresponding SRS resource is used, otherwise if a bit in the bitmap is “0” the corresponding SRS resource is not used, or vice versa.
A bitmap(s) included in the POs corresponding to the PEI. In one example, there is a one-to-one mapping between the bits of the bitmap and the M SRS resources configured by system information (e.g., SIB1 or other SIB). In one example, one bitmap is included in the PO for UEs that are being paged by the PO. In one example, a bitmap is included in PO for each subgroup of the PO. In one example, if a bit in the bitmap is “1” the corresponding SRS resource is used, otherwise if a bit in the bitmap is “0” the corresponding SRS resource is not used, or vice versa.
A list(s) of SRS resource IDs of the M resources configured by system information (e.g., SIB1 or other SIB) is included in the PEI. In one example, one list of SRS resource IDs is included in PEI for UEs that are being paged by the POs corresponding to the PEI. In one example, a list of SRS resource IDs is included in PEI for each PO in the PEI. In one example, a list of SRS resource IDs is included in PEI for each subgroup of a PO in the PEI.
A list(s) of SRS resource IDs of the M resources configured by system information (e.g., SIB1 or other SIB) is included in the POs corresponding to the PEI. In one example, one list of SRS resource IDs is included in the PO for UEs that are being paged by the PO. In one example, a list of SRS resource IDs is included in PO for each subgroup of the PO.
In a variant of the mentioned herein examples, the SRS configuration parameters (or a subset of them) for one or more SRS resources can be included in the PEI and/or a corresponding PO instead of, or in addition to, the SRS ID for the one or more SRS resources. Wherein the configuration parameters for the SRS resource can be as mentioned herein.

In one example, the SRS resource can be transmitted at or after a time T after the end (or start) of the PDCCH reception providing the PEI or the end (or start) of the physical channel (e.g., PDSCH) providing the PO or the end (or start) of the PDCCH reception providing the DCI Format scheduling the PO associated with the UE transmitting SRS. In one example, the slot or subframe or frame used to transmit SRS resource can be at or after a time T after the end (or start) of the PDCCH reception providing the PEI, or the end (or start) of the physical channel (e.g., PDSCH) providing the PO, or the end (or start) of the PDCCH reception providing the DCI Format scheduling the PO associated with the UE transmitting SRS. In one example, the slot or subframe or frame used to transmit SRS resource is that first slot or subframe or frame that starts at or after a time T after the end (or start) of the PDCCH reception providing the PEI, or the end (or start) of the physical channel (e.g., PDSCH) providing the PO, or the end (or start) of the PDCCH reception providing the DCI Format scheduling the PO associated with the UE transmitting SRS and optionally based on an offset and a periodicity as illustrated in FIG. 15, where SRS trigger can be replaced by PEI or the PO or the DCI Format scheduling the PO associated with the UE transmitting SRS. Wherein, the time T can be defined in the system specifications and/or configured or updated by network (e.g., using SIB signaling (SIB1 or other SIB) and/or RRC signaling and/or MAC CE signaling and/or L1 control signaling).

In one example SRS transmission is indicated during PEI/paging, but SRS transmission(s) start during or after a random access procedure as described later in this disclosure, wherein the random access procedure can be triggered in response to PEI/paging.

In one example, a PO includes a bit for each paged UE, wherein the bit indicates whether SRS is triggered or transmitted by the UE.

In one example, a PO includes a bit for each subgroup (or each subgroup with paged UEs), wherein the bit indicates whether SRS is triggered or transmitted by the paged UEs of that subgroup.

In one example, a PO includes a bit, wherein the bit indicates whether SRS is triggered or transmitted by the paged UEs of that PO.

In one example, the UE(s) transmitting the SRS is determined based on the paged UE(s) in the PO.

In one example, M SRS resources are configured by system information (e.g., SIB1 or other SIB). In one example, the SRS resource ID transmitted by a UE is determined based on one or more of the following:
The UE transmitting the SRS
The subgroup ID
The PO
The order of the paged UE in the PO or in a subgroup of the PO.

In one example, this mapping between the SRS resource ID and the mentioned herein parameters is based on a rule. In one example, this mapping between the SRS resource ID and the mentioned herein parameters is based on a network configuration. In one example, this mapping between the SRS resource ID and the mentioned herein parameters is based on a combination of a rule and network configuration.

In one example, the SRS resource ID transmitted by a UE is determined based on one or more of the following:
A bitmap(s) included in the PO. In one example, there is a one-to-one mapping between the bits of the bitmap and the M SRS resources configured by system information (e.g., SIB1 or other SIB). In one example, one bitmap is included in the PO for UEs that are being paged by the PO. In one example, a bitmap is included in PO for each subgroup of the PO. In one example, if a bit in the bitmap is “1” the corresponding SRS resource is used, otherwise if a bit in the bitmap is “0” the corresponding SRS resource is not used, or vice versa.
A list(s) of SRS resource IDs of the M resources configured by system information (e.g., SIB1 or other SIB) is included in the PO. In one example, one list of SRS resource IDs is included in the PO for UEs that are being paged by the PO. In one example, a list of SRS resource IDs is included in PO for each subgroup of the PO.
In a variant of the mentioned herein examples, the SRS configuration parameters (or a subset of them) for one or more SRS resources can be included in the PO instead of or in addition to the SRS ID for the one or more SRS resources. Wherein the configuration parameters for the SRS resource can be as mentioned herein.

In one example, the SRS resource can be transmitted at or after a time T after the end (or start) of the physical channel (e.g., PDSCH) providing the PO or the end (or start) of the PDCCH reception with the DCI Format scheduling the PO associated with the UE transmitting SRS. In one example, the slot or subframe or frame used to transmit SRS resource can be at or after a time T after the end (or start) of the physical channel (e.g., PDSCH) providing the PO or the end (or start) of the PDCCH reception providing the DCI Format scheduling the PO associated with the UE transmitting SRS. In one example, the slot or subframe or frame used to transmit SRS resource is that first slot or subframe or frame that starts at or after a time T after the end (or start) of the physical channel (e.g., PDSCH) providing the PO or the end (or start) of the PDCCH reception providing the DCI Format scheduling the PO associated with the UE transmitting SRS and optionally based on an offset and a periodicity as illustrated in FIG. 15, where SRS trigger can be replaced by PO or the end of the PDCCH reception providing the DCI Format scheduling the PO associated with the UE transmitting SRS. Wherein, the time T can be defined in the system specifications and/or configured or updated by network (e.g., the network 130) (e.g., using SIB signaling (e.g., SIB1 or other SIB) and/or RRC signaling and/or MAC CE signaling and/or L1 control signaling).

In one example SRS transmission is indicated during paging, but SRS transmission(s) start during or after a random access procedure as described later in this disclosure, wherein the random access procedure can be triggered in response to paging.

In one example, an SRS transmission is triggered in the random access response (RAR) (e.g., Msg2) to a preamble transmission. In one example, an SRS transmission is triggered in the random access response (RAR) (e.g., Msg2) to a preamble transmission for a contention based random access procedure. In one example, an SRS transmission is triggered in the random access response (RAR) (e.g., Msg2) to a preamble transmission for a contention free random access procedure.

In one example, a UE is configured e.g., by a field or flag in the system information to transmit SRS in response to receiving a RAR. In one example, the SRS transmission can be conditioned or further conditioned on whether the UE transmits an associated PRACH preamble from a first group of preambles or from a second group of preambles indicated in the system information (e.g., SIB1 or other SIB). For example, if the UE transmits a preamble from the first group of preambles, there is no SRS transmission, if the UE transmits a preamble from the second group of preamble the UE can transmit SRS (e.g., if triggered to transmit SRS). In one example, the first group of preambles are legacy preambles.

In one example, a UE is indicated in the RAR to transmit a SRS. In one example, a flag or a field in the RAR can indicate whether the UE transmits SRS in response to receiving the RAR. In one example, a field in the MAC sub-header for Random Access Response, e.g., a reserved field in the MAC sub-header for the Random Access Response can be used to trigger the SRS, for example, a value of “1” triggers the SRS, and a value of “0” doesn't trigger the SRS or vice versa. In one example, a field in the MAC RAR, e.g., a reserved field in the MAC RAR can be used to trigger the SRS, for example, a value of “1” triggers the SRS, and a value of “0” doesn't trigger the SRS or vice versa.

In one example, a UE is indicated by a flag (e.g., one-bit flag) or a special bit pattern in the RAR to transmit SRS. In one example, the UE transmits SRS instead of or in place of PUSCH Msg3. In one example, the UE transmits SRS in addition to PUSCH Msg3 (before or after PUSCH Msg3). In one example, the flag (e.g., one-bit flag) is included in the MAC sub-header for the Random Access Response, e.g., for Type-1 Random Access Procedure. In one example, the flag (e.g., one-bit flag) is included in the MAC RAR, e.g., for Type-1 Random Access Procedure. In one example, the flag (e.g., one-bit flag) is included in the RAR UL Grant of the MAC RAR, e.g., for Type-1 Random Access Procedure. In one example, a special bit pattern of fields in the RAR UL Grant of the MAC RAR, e.g., for Type-1 Random Access Procedure, indicates transmission of SRS. In one example, the flag (e.g., one-bit flag) is included in the DCI scheduling PDSCH of the MAC RAR. In one example, a special bit pattern of fields in the DCI scheduling the PDSCH of the MAC RAR indicates transmission of SRS.

In one example, a UE is indicated by a SRS resource in the RAR to use for SRS transmission. In one example, the UE transmits SRS instead of or in place of PUSCH Msg3. In one example, the UE transmits SRS in addition to PUSCH Msg3 (before or after PUSCH Msg3). In one example, the SRS resource is included in the MAC RAR, e.g., for Type-1 Random Access Procedure. In one example, the SRS resource is included in the RAR UL Grant of the MAC RAR, e.g., for Type-1 Random Access Procedure. In one example, the SRS resource is included in the DCI scheduling the PDSCH of the MAC RAR. In one example, the SRS resource is linked to (associated with) the preamble index. In one example, the SRS resource is linked to (associated with) the PRACH occasion. In one example, the SRS resource is linked to (associated with) the preamble index and the PRACH occasion. In one example, the SRS resource includes a SRS resource ID and/or SRS resource set ID configured to the UE from a list of SRS resources and/or a list of SRS resource sets configured to the UE, wherein the configuration can be by SIB signaling (e.g., SIB1 or other SIB) or by RRC signaling. In one example, the SRS resource includes configuration/scheduling parameters for the SRS, such as time domain resources (e.g., symbol(s) in a slot to use for SRS, time offset from the RAR, or time offset within a period, SRS period, etc.), frequency domain resources (e.g., starting PRB, number of PRBs, frequency hopping pattern, etc.), comb parameters (e.g., comb size, comb offset, cyclic shift, etc.), sequence, sequence hopping (e.g., group hopping, sequence hopping or neither, etc.). In one example, the RAR UL grant of the MAC RAR includes parameters to schedule the SRS resource.

In one example, a UE is indicated by a flag (e.g., one-bit flag) or a special bit pattern in the RAR to transmit SRS and is indicated an SRS resource in the RAR. In one example, the UE transmits SRS instead of or in place of PUSCH Msg3. In one example, the UE transmits SRS in addition to PUSCH Msg3 (before or after PUSCH Msg3). In one example, the SRS resource is linked to (associated with) the preamble index. In one example, the SRS resource is linked to (associated with) the PRACH occasion. In one example, the SRS resource is linked to (associated with) the preamble index and the PRACH occasion. In one example, the SRS resource includes a SRS resource ID and/or SRS resource set ID configured to the UE from a list of SRS resources and/or a list of SRS resource sets configured to the UE, wherein the configuration can be by SIB signaling (e.g., SIB1 or other SIB) or by RRC signaling. In one example, the SRS resource includes configuration/scheduling parameters for the SRS, such as time domain resources (e.g., symbol(s) in a slot to use for SRS, time offset from the RAR, or time offset within a period, SRS period, etc.), frequency domain resources (e.g., starting PRB, number of PRBs, frequency hopping pattern, etc.), comb parameters (e.g., comb size, comb offset, cyclic shift, etc.), sequence, sequence hopping (e.g., group hopping, sequence hopping or neither, etc.). In one example, the RAR UL grant of the MAC RAR includes parameters to schedule the SRS resource. The indication of the flag (e.g., one-bit flag) or special pattern and the SRS resource can follow one of the examples of Table 4.

TABLE 4

| | flag (e.g., one-bit | |
|---|---|---|
| Example | flag) or special | SRS resource |
| number | pattern provided by | provided by |
| Example 1 | MAC RAR | MAC RAR |
| Example 2 | MAC RAR | UL grant included |
| | | in MAC RAR |
| Example 3 | MAC RAR | DCI Format scheduling |
| | | PDSCH of MAC RAR |
| Example 4 | UL grant included | MAC RAR |
| | in MAC RAR | |
| Example 5 | UL grant included | UL grant included |
| | in MAC RAR | in MAC RAR |
| Example 6 | UL grant included | DCI Format scheduling |
| | in MAC RAR | PDSCH of MAC RAR |
| Example 7 | DCI Format scheduling | MAC RAR |
| | PDSCH of MAC RAR | |
| Example 8 | DCI Format scheduling | UL grant included |
| | PDSCH of MAC RAR | in MAC RAR |
| Example 9 | DCI Format scheduling | DCI Format scheduling |
| | PDSCH of MAC RAR | PDSCH of MAC RAR |

In one example, M SRS resources are configured by system information (e.g., SIB1 or other SIB). In one example, M SRS resources are configured by Msg4. In one example, the SRS resource ID transmitted by a UE is determined based on one or more of the following:
Based on a TC-RNTI conveyed by the RAR, e.g. the n least significant bits of the TC-RNTI, or the n most significant bits of the TC-RNTI, or indicated ID is TC-RNTI % N, or indicated ID is ceiling (TC-RNTI/N).
Based on a UE-ID indicated in or determined by a paging message that triggered the random access procedure associated with the RAR.
Based on the C-RNTI (or UE-ID), in Msg3, the UE and the gNB can identify a SRS resource (e.g., SRS resource in a stored context associated with the C-RNTI or the UE-ID)
Based on the preamble index associated with the RAR.
Based on the PRACH occasion (RO) associated with the RAR.
Based on the preamble index and PRACH occasion (RO) associated with the RAR.
The time and/or frequency resources of a PDCCH reception providing a DCI format scheduling a RAR or of the PDSCH reception providing the RAR.

In one example, the network configures SRS resource for each preamble-ID. In one example, the network configures SRS resource for each RO within a frame. In one example, the network configures SRS resource for each RO within an association period. In one example, the network configures SRS resource for each RO within an association pattern period. In one example, the network configures SRS resource for each RO within N frames, wherein N is configured and/or updated RRC and/or MAC CE and L1 control (e.g., DCI format) signaling, or N is specified in the system specifications, e.g., N=16, or N=8.

In one example, the network configures SRS resource for each preamble-ID-RO pair. Wherein, RO can be:
Within a frame.
Within an association period.
Within an association pattern period.
Within N frames, wherein N is configured and/or updated RRC and/or MAC CE and L1 control (e.g., DCI format) signaling, or N is specified in the system specifications, e.g., N=16, or N=8.

In one example, this mapping between the SRS resource ID and the mentioned herein parameters is based on a rule. In one example, this mapping between the SRS resource ID and the mentioned herein parameters is based on a network configuration. In one example, this mapping between the SRS resource ID and the mentioned herein parameters is based on a combination of a rule and network configuration.

In one example, the SRS resource ID transmitted by a UE is determined based on one or more of the following:
A SRS ID of the M SRS resource IDs configured by system information (e.g., SIB1 or other SIB), or configured in Msg4, wherein the SRS resource ID is included in the DCI Format scheduling the RAR and/or the RAR.
In a variant, the SRS configuration parameters (or a subset of them) for the SRS resource can be included in the DCI Format scheduling the RAR and/or the RAR instead of or in addition to the SRS ID. Wherein the configuration parameters for the SRS resource can be as mentioned herein

In one example, the SRS resource can be transmitted at or after a time T after the end (or start) of the PDSCH reception providing the RAR or of end (or start) of the PDCCH reception providing the DCI Format scheduling the RAR associated with the UE transmitting SRS. In one example, the slot or subframe or frame used to transmit SRS resource can be at or after a time T after the end (or start) of PDSCH reception providing the RAR or of end (or start) of the PDCCH reception providing the DCI Format scheduling the RAR associated with the UE transmitting SRS. In one example, the slot or subframe or frame used to transmit SRS resource is that first slot or subframe or frame that starts at or after a time T after the end (or start) of PDSCH reception providing the RAR or of end (or start) of PDCCH reception providing the DCI Format scheduling the RAR associated with the UE transmitting SRS and optionally based on an offset and a periodicity as illustrated in FIG. 15, where SRS trigger can be replaced by the PDSCH providing the RAR or the PDCCH providing the DCI Format scheduling the RAR associated with the UE transmitting SRS. Wherein, the time T can be defined in the system specifications (e.g., SIB1 or other SIB) and/or configured or updated by network (e.g., using SIB signaling and/or RRC signaling and/or MAC CE signaling and/or L1 control signaling).

In one example, the RAR and/or DCI scheduling the RAR includes a flag to trigger SRS. The SRS is transmitted after RACH Msg3. In one example, the UE has a stored context and the store context is associated with a C-RNTI (or a UE ID) or I-RNTI, for example the UE is in INACTIVE state. In one example, the UE transmits a C-RNTI MAC CE (or UE ID) in the Msg3, based on the C-RNTI (or UE-ID) the UE and the gNB (e.g., the BS 102) can identify a SRS resource (e.g., SRS resource in a stored context associated with the C-RNTI or I-RNTI or the UE-ID).

In one example, the SRS resource can be transmitted at or after a time T after the end (or start) of the PUSCH transmission containing Msg3 associated with the UE transmitting SRS. In one example, the slot or subframe or frame used to transmit SRS resource can be at or after a time T after the end (or start) of the PUSCH transmission containing Msg3 associated with the UE transmitting SRS. In one example, the slot or subframe or frame used to transmit SRS resource is that first slot or subframe or frame that starts at or after a time T after the end (or start) of the PUSCH transmission containing Msg3 associated with the UE transmitting SRS and optionally based on an offset and a periodicity as illustrated in FIG. 15, where SRS trigger can be replaced by the PUSCH transmission containing Msg3 associated with the UE transmitting SRS. Wherein, the time T can be defined in the system specifications (SIB1 other SIB) and/or configured or updated by network (e.g., using SIB signaling and/or RRC signaling and/or MAC CE signaling and/or L1 control signaling).

In one example, an SRS transmission is triggered in contention resolution message providing a C-RNTI for the UE, or in Msg4, of a random access procedure. In one example, an SRS transmission is triggered in contention resolution message or Msg4 of a contention-based random access procedure. In one example, an SRS transmission is triggered in Msg4 of a contention-free random access procedure.

In one example, a UE is configured e.g., by a field or flag in the system information to transmit SRS in response to receiving a contention resolution message, or in Msg4, or in a DCI Format scheduling Msg4. For brevity, only the contention resolution message or Msg4 is referred to in the following.

In one example, the SRS transmission can be conditioned or further conditioned on whether the UE transmits an associated PRACH preamble from a first group of preambles or from a second group of preambles indicated in the system information (e.g., SIB1 or other SIB). For example, if the UE transmits a preamble from the first group of preambles, there is no SRS transmission, if the UE transmits a preamble from the second group of preamble the UE can transmit SRS (e.g., if triggered to transmit SRS). In one example, the first group of preambles are legacy preambles.

In one example, a UE is indicated in the contention resolution message to transmit a SRS. In one example, a flag or a field in the contention resolution message can indicate whether the UE transmits SRS in response to receiving the contention resolution message.

In one example, a MAC CE or information element (IE) in the contention resolution message can provide a configuration for SRS transmission by the UE.

In one example, M SRS resources are configured by system information (e.g., SIB1 or other SIB). In one example, M SRS resources are configured by Msg4. In one example, the SRS resource ID transmitted by a UE is determined based on one or more of the following:
Based on a C-RNTI conveyed by the contention resolution, e.g. the n least significant bits of the C-RNTI, or the n most significant bits of the C-RNTI, or indicated ID is C-RNTI % N, or indicated ID is ceiling (C-RNTI/N).
Based on the C-RNTI (or UE-ID) or I-RNTI the UE and the gNB can identify a SRS resource (e.g., SRS resource in a stored context associated with the C-RNTI or the UE-ID or I-RNTI).
Based on a TC-RNTI used by the random access procedure, e.g. the n least significant bits of the TC-RNTI, or the n most significant bits of the TC-RNTI, or indicated ID is TC-RNTI % N, or indicated ID is ceiling (TC-RNTI/N).
Based on a UE-ID indicated in a paging message that triggered the random access procedure associated with the contention resolution.
Based on the preamble index associated with the random access procedure.
Based on the PRACH occasion (RO) associated with the RAR or random access procedure.
Based on the preamble index and PRACH occasion (RO) associated with the RAR or random access procedure.
The time and/or frequency resources of a DCI format scheduling a contention resolution or of the contention resolution.
Based on the resource used for HARQ-ACK acknowledgment of contention resolution.
Based on an information provided by a MAC CE or information element in the contention resolution message.

In one example, the network configures SRS resource for each preamble-ID. In one example, the network configures SRS resource for each RO within a frame. In one example, the network configures SRS resource for each RO within an association period. In one example, the network configures SRS resource for each RO within an association pattern period. In one example, the network configures SRS resource for each RO within N frames, wherein N is configured and/or updated RRC and/or MAC CE and L1 control (e.g., DCI format) signaling, or N is specified in the system specifications, e.g., N=16, or N=8.

In one example, the network configures SRS resource for each preamble-ID-RO pair. Wherein, RO can be:
Within a frame.
Within an association period.
Within an association pattern period.
Within N frames, wherein N is configured and/or updated RRC and/or MAC CE and L1 control (e.g., DCI format) signaling, or N is specified in the system specifications, e.g., N=16, or N=8.

In one example, this mapping between the SRS resource ID and the mentioned herein parameters is based on a rule. In one example, this mapping between the SRS resource ID and the mentioned herein parameters is based on a network configuration. In one example, this mapping between the SRS resource ID and the mentioned herein parameters is based on a combination of a rule and network configuration.

In one example, the SRS resource ID transmitted by a UE is determined based on one or more of the following:
A SRS ID of the M SRS resource IDs configured by system information (e.g., SIB1 other SIB), or configured in Msg4, wherein the SRS resource ID is included in the DCI Format scheduling the contention resolution and/or in the contention resolution message.
In a variant, the SRS configuration parameters (or a subset of them) for the SRS resource can be included in the DCI Format scheduling the contention resolution message and/or in the contention resolution message instead of or in addition to the SRS ID. Wherein the configuration parameters for the SRS resource can be as mentioned herein.

In one example, the SRS resource can be transmitted at or after a time T after the end (or start) of the PDSCH reception providing the contention resolution message or of the PDCCH reception providing the DCI Format scheduling the contention resolution message associated with the UE transmitting SRS. In one example, the SRS resource can be transmitted at or after a time T after the end (or start) of the channel (e.g., PUCCH or PUSCH) carrying the acknowledgment of Msg4 associated with the UE transmitting SRS. In one example, the slot or subframe or frame used to transmit SRS resource can be at or after a time T after the end (or start) of the PDSCH reception providing the contention resolution message or of the PDCCH reception providing the DCI Format scheduling the contention resolution message associated with the UE transmitting SRS. In one example, the slot or subframe or frame used to transmit SRS resource can be at or after a time T after the end (or start) of the channel (e.g., PUCCH or PUSCH) carrying the acknowledgment of Msg4 associated with the UE transmitting SRS. In one example, the slot or subframe or frame used to transmit SRS resource is that first slot or subframe or frame that starts at or after a time T after the end (or start) of the PDSCH reception providing the contention resolution message or of the PDCCH reception providing the DCI Format scheduling the contention resolution message associated with the UE transmitting SRS and optionally based on an offset and a periodicity as illustrated in FIG. 15, where SRS trigger can be replaced by the PDSCH providing the contention resolution message or the PDCCH providing the DCI Format scheduling the contention resolution message associated with the UE transmitting SRS transmission. In one example, the slot or subframe or frame used to transmit SRS resource is that first slot or subframe or frame that starts at or after a time T after the end (or start) of the channel (e.g., PUCCH or PUSCH) carrying the acknowledgment of Msg4 associated with the UE transmitting SRS and optionally based on an offset and a periodicity as illustrated in FIG. 15, where SRS trigger can be replaced by the channel carrying the acknowledgment. Wherein, the time T can be defined in the system specifications and/or configured or updated by network (e.g., using SIB signaling (e.g., SIB1 or other SIB) and/or RRC signaling and/or MAC CE signaling and/or L1 control signaling). In one example, T can be provided in Msg4.

In one example, an SRS transmission is triggered in MsgB of a Type-2 random access procedure. In one example, MsgB is for successRAR. In one example, MsgB is for a fallback RAR. In one example, an SRS transmission is triggered in MsgB successRAR of a contention-based random access procedure. In one example, an SRS transmission is triggered in MsgB fallbackRAR of a contention-free random access procedure.

In one example, a UE (e.g., the UE 116) is configured e.g., by a field or flag in the system information to transmit SRS in response to receiving a MsgB.

In one example, the SRS transmission can be conditioned or further conditioned on whether the UE transmits an associated PRACH preamble from a first group of preambles or from a second group of preambles indicated in the system information (e.g., SIB1 or other SIB). For example, if the UE transmits a preamble from the first group of preambles, there is no SRS transmission, if the UE transmits a preamble from the second group of preamble the UE transmits SRS. In one example, the first group of preambles are legacy preambles.

In one example, a UE is indicated in the MsgB to transmit a SRS. In one example, a flag or a field in the MsgB can indicate whether the UE transmits SRS in response to receiving the MsgB. In one example, MsgB can include a fallback RAR. In one example, MsgB can include a success RAR. In one example, a field in the MAC sub-header for success RAR or the fallback RAR, e.g., a reserved field in the MAC sub-header for the success RAR or fallback RAR can be used to trigger the SRS, for example, a value of “1” triggers the SRS, and a value of “0” doesn't trigger the SRS or vice versa. In one example, a field in the success RAR or fallback RAR, e.g., a reserved field in the success RAR or fallback RAR can be used to trigger the SRS, for example, a value of “1” triggers the SRS, and a value of “0” doesn't trigger the SRS or vice versa.

In one example, a UE is indicated by a flag (e.g., one-bit flag) or a special bit pattern in the MsgB (e.g., fallbackRAR or successRAR) to transmit SRS or the DCI Format scheduling MsgB. In one example, the UE transmits SRS instead of or in place of PUSCH Msg3. In one example, the UE transmits SRS in addition to PUSCH Msg3, e.g., scheduled by fallbackRAR, (before or after PUSCH Msg3). In one example, the flag (e.g., one-bit flag) is included in the MAC sub-header for the success RAR or fallback RAR, e.g., for Type-2 Random Access Procedure. In one example, the flag (e.g., one-bit flag) is included in MsgB (e.g., fallbackRAR or successRAR), e.g., for Type-2 Random Access Procedure. In one example, the flag (e.g., one-bit flag) is included in the UL Grant of MsgB (e.g., fallbackRAR), e.g., for Type-2 Random Access Procedure. In one example, a special bit pattern of fields in the UL Grant of MsgB (e.g., fallbackRAR), e.g., for Type-2 Random Access Procedure, indicates transmission of SRS. In one example, the flag (e.g., one-bit flag) is included in the DCI scheduling PDSCH of MsgB (e.g., fallbackRAR or successRAR). In one example, a special bit pattern of fields in the DCI scheduling the PDSCH of MsgB (e.g., fallbackRAR or successRAR) indicates transmission of SRS.

In one example, a UE is indicated by a SRS resource in MsgB (e.g., fallbackRAR or successRAR) to use for SRS transmission. In one example, the UE transmits SRS instead of or in place of PUSCH Msg3. In one example, the UE transmits SRS in addition to PUSCH Msg3, e.g., scheduled by fallbackRAR, (before or after PUSCH Msg3). In one example, the SRS resource is included in MsgB (e.g., fallbackRAR or successRAR), e.g., for Type-2 Random Access Procedure. In one example, the SRS resource is included in the UL Grant of MsgB (e.g., fallbackRAR), e.g., for Type-2 Random Access Procedure. In one example, the SRS resource is included in the DCI scheduling the PDSCH of MsgB (e.g., fallbackRAR or successRAR). In one example, the SRS resource is linked to (associated with) the preamble index. In one example, the SRS resource is linked to (associated with) the PRACH occasion. In one example, the SRS resource is linked to (associated with) the preamble index and the PRACH occasion. In one example, the SRS resource includes a SRS resource ID and/or SRS resource set ID configured to the UE from a list of SRS resources and/or a list of SRS resource sets configured to the UE, wherein the configuration can be by SIB signaling (e.g., SIB1 or other SIB) or by RRC signaling. In one example, the SRS resource includes configuration/scheduling parameters for the SRS, such as time domain resources (e.g., symbol(s) in a slot to use for SRS, time offset from MsgB (e.g., fallbackRAR or successRAR), or time offset within a period, SRS period, etc.), frequency domain resources (e.g., starting PRB, number of PRBs, frequency hopping pattern, etc.), comb parameters (e.g., comb size, comb offset, cyclic shift, etc.), sequence, sequence hopping (e.g., group hopping, sequence hopping or neither, etc.). In one example, the UL grant of the fallbackRAR includes parameters to schedule the SRS resource. In one example, the successRAR includes an UL grant with parameters to schedule the SRS resource.

In one example, a UE is indicated by a flag (e.g., one-bit flag) or a special bit pattern in MsgB (e.g., fallbackRAR or successRAR) to transmit SRS and is indicated an SRS resource in MsgB (e.g., fallbackRAR or successRAR). In one example, the UE transmits SRS instead of or in place of PUSCH Msg3, e.g., scheduled by fallbackRAR. In one example, the UE transmits SRS in addition to PUSCH Msg3 (before or after PUSCH Msg3). In one example, the SRS resource is linked to (associated with) the preamble index. In one example, the SRS resource is linked to (associated with) the PRACH occasion. In one example, the SRS resource is linked to (associated with) the preamble index and the PRACH occasion. In one example, the SRS resource includes a SRS resource ID and/or SRS resource set ID configured to the UE from a list of SRS resources and/or a list of SRS resource sets configured to the UE, wherein the configuration can be by SIB signaling (e.g., SIB1 or other SIB) or by RRC signaling. In one example, the SRS resource includes configuration/scheduling parameters for the SRS, such as time domain resources (e.g., symbol(s) in a slot to use for SRS, time offset from MsgB (e.g., fallbackRAR or successRAR), or time offset within a period, SRS period, etc.), frequency domain resources (e.g., starting PRB, number of PRBs, frequency hopping pattern, etc.), comb parameters (e.g., comb size, comb offset, cyclic shift, etc.), sequence, sequence hopping (e.g., group hopping, sequence hopping or neither, etc.). In one example, the UL grant of the fallbackRAR includes parameters to schedule the SRS resource. In one example, the successRAR includes an UL grant with parameters to schedule the SRS resource. The indication of the flag (e.g., one-bit flag) or special pattern and the SRS resource can follow one of the examples of Table 5.

TABLE 5

| Example | flag (e.g., one-bit flag) or | |
|---|---|---|
| number | special pattern provided by | SRS resource provided by |
| Example 1 | MsgB (e.g., fallbackRAR or | MsgB (e.g., fallbackRAR or |
| | successRAR) | successRAR) |
| Example 2 | MsgB (e.g., fallbackRAR or | UL grant included in |
| | successRAR) | MsgB (e.g., fallbackRAR) |
| Example 3 | MsgB (e.g., fallbackRAR or | DCI Format scheduling |
| | successRAR) | PDSCH of MsgB (e.g., |
| | | fallbackRAR or successRAR) |
| Example 4 | UL grant included in | MsgB (e.g., fallbackRAR or |
| | MsgB (e.g., fallbackRAR) | successRAR) |
| Example 5 | UL grant included in | UL grant included in |
| | MsgB (e.g., fallbackRAR) | MsgB (e.g., fallbackRAR) |
| Example 6 | UL grant included in | DCI Format scheduling |
| | MsgB (e.g., fallbackRAR) | PDSCH of MsgB (e.g., |
| | | fallbackRAR or successRAR) |
| Example 7 | DCI Format scheduling | MsgB (e.g., fallbackRAR or |
| | PDSCH of MsgB (e.g., | successRAR) |
| | fallbackRAR or successRAR) | |
| Example 8 | DCI Format scheduling | UL grant included in |
| | PDSCH of MsgB (e.g., | MsgB (e.g., fallbackRAR) |
| | fallbackRAR or successRAR) | |
| Example 9 | DCI Format scheduling | DCI Format scheduling |
| | PDSCH of MsgB (e.g., | PDSCH of MsgB (e.g., |
| | fallbackRAR or successRAR) | fallbackRAR or successRAR) |

In one example, M SRS resources are configured by system information (e.g., SIB1 or other SIB). In one example, M SRS resources are configured by MsgB. In one example, the SRS resource ID transmitted by a UE is determined based on one or more of the following:
Based on a C-RNTI or I-RNTI conveyed by the MsgB, e.g. the n least significant bits of the C-RNTI, or the n most significant bits of the C-RNTI, or indicated ID is C-RNTI % N, or indicated ID is ceiling (C-RNTI/N).
Based on the C-RNTI (or UE-ID) or I-RNTI the UE and the gNB can identify a SRS resource (e.g., SRS resource in a stored context associated with the C-RNTI or the UE-ID or I-RNTI).
Based on a TC-RNTI used by the random access procedure, e.g. the n least significant bits of the TC-RNTI, or the n most significant bits of the TC-RNTI, or indicated ID is TC-RNTI % N, or indicated ID is ceiling (TC-RNTI/N).
Based on a UE-ID indicated in a paging message that triggered the random access procedure associated with the MsgB.
Based on the preamble index associated with the random access procedure.
Based on the PRACH occasion (RO) associated with the random access procedure.
Based on the preamble index and PRACH occasion (RO) associated with the random access procedure.
The time and/or frequency resources of a DCI format scheduling a MsgB or of the MsgB.
Based on the resource used for HARQ-ACK acknowledgment of MsgB.
Based on information provided in MsgB

In one example, the network (e.g., the network 130) configures SRS resource for each preamble-ID. In one example, the network configures SRS resource for each RO within a frame. In one example, the network configures SRS resource for each RO within an association period. In one example, the network configures SRS resource for each RO within an association pattern period. In one example, the network configures SRS resource for each RO within N frames, wherein N is configured and/or updated RRC and/or MAC CE and L1 control (e.g., DCI format) signaling, or Nis specified in the system specifications, e.g., N=16, or N=8.

In one example, the network configures SRS resource for each preamble-ID-RO pair. Wherein, RO can be:
Within a frame.
Within an association period.
Within an association pattern period.
Within N frames, wherein N is configured and/or updated RRC and/or MAC CE and L1 control (e.g., DCI format) signaling, or N is specified in the system specifications, e.g., N=16, or N=8.

In one example, this mapping between the SRS resource ID and the mentioned herein parameters is based on a rule. In one example, this mapping between the SRS resource ID and the mentioned herein parameters is based on a network configuration. In one example, this mapping between the SRS resource ID and the mentioned herein parameters is based on a combination of a rule and network configuration.

In one example, the SRS resource ID transmitted by a UE is determined based on one or more of the following:
A SRS ID of the M SRS resource IDs configured by system information (e.g., SIB1 or other SIB) or configured in MsgB, wherein the SRS resource ID is included in the DCI Format scheduling the MsgB and/or the MsgB.
In a variant, the SRS configuration parameters (or a subset of them) for the SRS resource can be included in the DCI Format scheduling the MsgB and/or the MsgB instead of or in addition to the SRS ID. Wherein the configuration parameters for the SRS resource can be as mentioned herein.

In one example, the SRS resource can be transmitted at or after a time T after the end (or start) of the PDSCH reception providing MsgB or of the PDCCH reception providing the DCI Format scheduling the MsgB associated with the UE transmitting SRS. In one example, the SRS resource can be transmitted at or after a time T after the end (or start) of the channel (e.g., PUCCH or PUSCH) carrying the acknowledgment of MsgB associated with the UE transmitting SRS. In one example, the slot or subframe or frame used to transmit SRS resource can be at or after a time T after the end (or start) of the PDSCH reception providing MsgB or of the PDCCH reception providing the DCI Format scheduling the MsgB associated with the UE transmitting SRS. In one example, the slot or subframe or frame used to transmit SRS resource can be at or after a time T after the end (or start) of the channel (e.g., PUCCH or PUSCH) carrying the acknowledgment of MsgB associated with the UE transmitting SRS. In one example, the slot or subframe or frame used to transmit SRS resource is that first slot or subframe or frame that starts at or after a time T after the end (or start) of the PDSCH reception providing MsgB or of the PDCCH reception providing the DCI Format scheduling the MsgB associated with the UE transmitting SRS and optionally based on an offset and a periodicity as illustrated in FIG. 15, where SRS trigger can be replaced by the MsgB or the PDCCH reception providing the DCI Format scheduling the MsgB associated with the UE transmitting SRS. In one example, the slot or subframe or frame used to transmit SRS resource is that first slot or subframe or frame that starts at or after a time T after the end (or start) of the channel (e.g., PUCCH or PUSCH) carrying the acknowledgment of MsgB associated with the UE transmitting SRS and optionally based on an offset and a periodicity as illustrated in FIG. 15, where SRS trigger can be replaced by the channel carrying the acknowledgment. Wherein, the time T can be defined in the system specifications and/or configured or updated by network (e.g., using SIB signaling (e.g., SIB1 other SIB) and/or RRC signaling and/or MAC CE signaling and/or L1 control signaling). In one example, T can be provided in MsgB.

In the mentioned herein examples,
UE transmits a preamble for a Type-1 random access procedure or a Type-2 random access procedure. In one example, a Type-2 random access procedure includes a PRACH and a PUSCH.
The network responds to the preamble of the Type-1 random access procedure or the Type-2 random access procedure, with a RAR or a success RAR or a fallback RAR.
   In one example, the RAR or a success RAR or a fallback RAR includes a trigger for SRS,
   In one example, the RAR or a success RAR or a fallback RAR indicates a resource for SRS, e.g., explicitly or based on preamble ID or RO or TC-RNTI or C-RNTI as mentioned herein.
   In one example, the SRS resource is transmitted before Msg3.
   In one example, the SRS resource is transmitted after Msg3.
   In one example, the SRS resource is transmitted with (or as part of) Msg3.
   In one example, the SRS resource is transmitted after Msg4.
   In one example, the SRS resource is transmitted after UE is in connected state.
For type 1 random access procedure, the UE transmits Msg3. In one example, Msg3 includes C-RNTI MAC CE or common control channel (CCCH) service data unit (SDU).
The network responds to the Msg3 of the Type-1 random access procedure with a Msg4
   In one example, the Msg4 includes a trigger for SRS,
   In one example, the Msg4 indicates a resource for SRS, e.g., explicitly or based on preamble ID or RO or TC-RNTI or C-RNTI as mentioned herein.
   In one example, the SRS resource is transmitted after UE is in connected state.

In one example, the SRS is transmitted associated with PRACH preamble. In one example, a UE can be configured by system information (e.g., SIB1 or other SIB) to transmit SRS associated with or after a PRACH preamble. In one example, a UE can be indicated by a PEI and/or a paging message to transmit SRS associated with or after a PRACH preamble as mentioned herein. The SRS transmission can be conditioned or further conditioned on whether the UE transmits an associated PRACH preamble from a first group of preambles or from a second group of preambles indicated in the system information (e.g., SIB1 or other SIB). For example, if the UE transmits a preamble from the first group of preambles, there is no SRS transmission, if the UE transmits a preamble from the second group of preamble the UE can transmit SRS (e.g., if triggered to transmit SRS). In one example, the first group of preambles are legacy preambles.

In one example, the SRS resource can be transmitted at or after a time T after the end (or start) of the PRACH transmission associated with the UE transmitting SRS. In one example, the slot or subframe or frame used to transmit SRS resource can be at or after a time T from the end (or start) of the PRACH transmission associated with the UE transmitting SRS. In one example, the slot or subframe or frame used to transmit SRS resource is that first slot or subframe or frame that starts at or after a time T from the end (or start) of the PRACH transmission associated with the UE transmitting SRS. Wherein, the time T can be defined in the system specifications and/or configured or updated by network (e.g., using SIB signaling (e.g., SIB1 or other SIB) and/or RRC signaling and/or MAC CE signaling and/or L1 control signaling). In one example, a PRACH occasion is mapped to a SRS occasion where the UE can transmit SRS. In one example, a one or more PRACH occasions are mapped to a SRS occasion where the UE can transmit SRS. In one example, a PRACH occasion is mapped to one or more SRS occasions where the UE can transmit SRS, for example, one or more preambles of a PRACH occasion are mapped to a SRS occasion.

In one example, the transmission of SRS associated with PRACH is as illustrated in FIG. 15, where SRS trigger can be replaced by PRACH transmission.

In one example, the SRS is associated with a RACH scheduled PUSCH transmission or a Msg 3. In one example, a UE can be configured by system information (e.g., SIB1 or other SIB) to transmit SRS associated with or after a Msg3. In one example, a UE can be indicated by a PEI and/or a paging message to transmit SRS associated with or after a Msg3 as mentioned herein. In one example, a UE can be indicated by a RAR to transmit SRS associated with or after a Msg3 as mentioned herein. The SRS transmission can be conditioned or further conditioned on whether the UE transmits an associated PRACH preamble from a first group of preambles or from a second group of preambles indicated in the system information (e.g., SIB1 or other SIB). For example, if the UE transmits a preamble from the first group of preambles, there is no SRS transmission, if the UE transmits a preamble from the second group of preamble the UE can transmit SRS (e.g., if triggered to transmit SRS). In one example, a UE can indicate in the Msg3 (e.g., by flag) whether or not there is an SRS transmission associated with Msg3.

In one example, the SRS resource can be transmitted at or after a time T after the end (or start) of the PUSCH transmission providing Msg3 associated with the UE transmitting SRS. In one example, the slot or subframe or frame used to transmit SRS resource can be at or after a time T after the end (or start) of the Msg3 PUSCH transmission associated with the UE transmitting SRS. In one example, the slot or subframe or frame used to transmit SRS resource is that first slot or subframe or frame that starts at or after a time T after the end (or start) of the Msg3 PUSCH transmission associated with the UE transmitting SRS. Wherein, the time T can be defined in the system specifications and/or configured or updated by network (e.g., using SIB signaling (e.g., SIB1 or other SIB) and/or RRC signaling and/or MAC CE signaling and/or L1 control signaling).

In one example, the transmission of SRS associated with Msg3 is as illustrated in FIG. 15, where SRS trigger can be replaced by PUSCH transmission providing Msg3.

In one example, the SRS is associated with a MsgA of Type-2 random access procedure. In one example, a UE can be configured by system information (e.g., SIB1 or other SIB) to transmit SRS associated with or after a MsgA. In one example, a UE can be indicated by a PEI and/or a paging message to transmit SRS associated with or after a MsgA as mentioned herein. The SRS transmission can be conditioned or further conditioned on whether the UE transmits an associated msgA PRACH preamble from a first group of preambles or from a second group of preambles indicated in the system information. For example, if the UE transmits a preamble from the first group of preambles, there is no SRS transmission, if the UE transmits a preamble from the second group of preamble the UE can transmit SRS (e.g., if triggered to transmit SRS). In one example, the first group of preambles are legacy preambles. In one example, a UE can indicate in the MsgA PUSCH (e.g., by flag) whether or not there is an SRS transmission associated with MsgA.

In one example, the SRS resource can be transmitted at or after a time T from the end (or start) of the MsgA (e.g., MsgA PRACH or MsgA PUSCH) transmission associated with the UE transmitting SRS. In one example, the slot or subframe or frame used to transmit SRS resource can be at or after a time T from the end (or start) of the MsgA (e.g., MsgA PRACH or MsgA PUSCH) transmission associated with the UE transmitting SRS. In one example, the slot or subframe or frame used to transmit SRS resource is that first slot or subframe or frame that starts at or after a time T from the end (or start) of the MsgA (e.g., MsgA PRACH or MsgA PUSCH) transmission associated with the UE transmitting SRS. Wherein, the time T can be defined in the system specifications and/or configured or updated by network (e.g., using SIB signaling (e.g., SIB1 or other SIB) and/or RRC signaling and/or MAC CE signaling and/or L1 control signaling). In one example, a PRACH occasion is mapped to a SRS occasion where the UE can transmit SRS. In one example, a one or more PRACH occasions are mapped to a SRS occasion where the UE can transmit SRS. In one example, a PRACH occasion is mapped to one or more SRS occasions where the UE can transmit SRS, for example, one or more preambles of a PRACH occasion are mapped to a SRS occasion.

In one example, the transmission of SRS associated with MsgA is as illustrated in FIG. 15, where SRS trigger can be replaced by MsgA PRACH transmission.

In one example, the transmission of SRS associated with MsgA is as illustrated in FIG. 15, where SRS trigger can be replaced by MsgA PUSCH transmission.

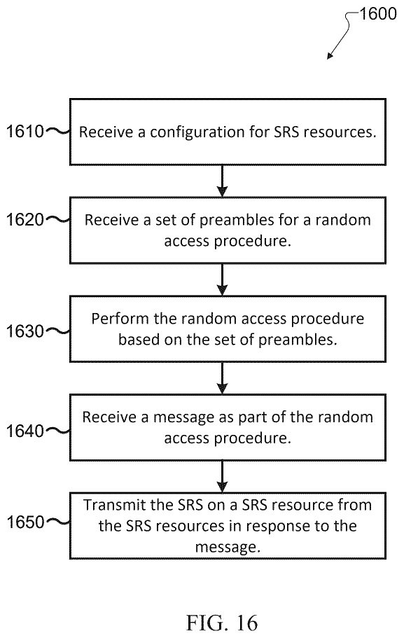

FIG. 16 illustrates an example method 1600 performed by a UE in a wireless communication system according to embodiments of the present disclosure. The method 1600 of FIG. 16 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1600 is for illustration only and other embodiments can be used without departing from the scope of the present disclosure.

The method 1600 begins with the UE receiving a configuration for SRS resources (1610). In various embodiments, the configuration of the SRS resources is provided in a SIB1 or the message.

The UE then receives a set of preambles for a random access procedure (1620). For example, in 1620, the set of preambles is associated with transmission of a SRS when the UE supports transmission of the SRS in response to an indication associated with the random access procedure. In various embodiments, the random access procedure is a Type-1 random access procedure, and the message is a Msg4 or a contention resolution message of the random access procedure. In various embodiments, the random access procedure is a Type-2 random access procedure, and the message is a MsgB of the random access procedure.

The UE then performs the random access procedure based on the set of preambles (1630). The UE then receives a message as part of the random access procedure (1640). For example, in 1640, the message triggers transmission of the SRS. In various embodiments, the message includes a SRS resource ID of the SRS resource that is triggered for transmission.

The UE then transmits the SRS on a SRS resource from the SRS resources in response to the message (1650). In various embodiments, the UE determines a SRS resource ID of the SRS resource triggered for transmission based on a preamble index or a PRACH occasion used for the random access procedure. In various embodiments, the SRS is transmitted in a slot that starts at a time T from a time of reception of the message, and the time T is configured by SIB1 or other SIB.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a processor; and
a transceiver operably coupled to the processor, the transceiver configured to:
receive a configuration for sounding reference signal (SRS) resources,
receive a set of preambles for a random access procedure, wherein the set of preambles is associated with transmission of a SRS when the UE supports transmission of the SRS in response to an indication associated with the random access procedure,
perform the random access procedure based on the set of preambles,
receive a message as part of the random access procedure, wherein the message triggers transmission of the SRS, and
transmit the SRS on a SRS resource from the SRS resources in response to the message.

2. The UE of claim 1, wherein the configuration of the SRS resources is provided in a system information block 1 (SIB1) or the message.

3. The UE of claim 1, wherein:
the random access procedure is a Type-1 random access procedure, and
the message is a message four (Msg4) or a contention resolution message of the random access procedure.

4. The UE of claim 1, wherein:
the random access procedure is a Type-2 random access procedure, and
the message is a message B (MsgB) of the random access procedure.

5. The UE of claim 1, wherein the message includes a SRS resource identifier (ID) of the SRS resource that is triggered for transmission.

6. The UE of claim 1, wherein the processor is configured to determine a SRS resource identifier (ID) of the SRS resource triggered for transmission based on (i) a preamble index or (ii) a physical random access channel (PRACH) occasion used for the random access procedure.

7. The UE of claim 1, wherein:
the SRS is transmitted in a slot that starts at a time T from a time of reception of the message, and
the time T is configured by a system information block 1 (SIB1).

8. A base station (BS), comprising:
a transceiver configured to:
transmit, to a user equipment (UE), a configuration for sounding reference signal (SRS) resources,
transmit a configuration information for a set of preambles for a random access procedure, wherein the set of preambles is associated with reception of a SRS in response to an indication associated with the random access procedure, and
receive a preamble from the set of preambles as part of the random access procedure; and
a processor operably coupled to the transceiver, the processor configured to determine a SRS resource from the SRS resources,
wherein the transceiver is further configured to:
transmit a message as part of the random access procedure, wherein the message triggers transmission of the SRS, and
receive the SRS on the SRS resource in response to the message.

9. The BS of claim 8, wherein the configuration of the SRS resources is provided in system information block 1 (SIB1) or the message.

10. The BS of claim 8, wherein:
the random access procedure is a Type-1 random access procedure, and
the message is a message four (Msg4) or a contention resolution message of the random access procedure.

11. The BS of claim 8, wherein:
the random access procedure is a Type-2 random access procedure, and
the message is a message B (MsgB) of the random access procedure.

12. The BS of claim 8, wherein the message includes a SRS resource identifier (ID) of the SRS resource that is triggered for transmission.

13. The BS of claim 8, wherein the SRS resource triggered for transmission is based on (i) a preamble index or (ii) a physical random access channel (PRACH) occasion used for the random access procedure.

14. The BS of claim 8, wherein:
the SRS is received in a slot that starts at a time T from a time of reception of the message, and
the time T is configured by a system information block 1 (SIB1).

15. A method of operating a user equipment (UE), the method comprising:
receiving a configuration for sounding reference signal (SRS) resources;
receiving a set of preambles for a random access procedure, wherein the set of preambles is associated with transmission of a SRS when the UE supports transmission of the SRS in response to an indication associated with the random access procedure;
performing the random access procedure based on the set of preambles;
receiving a message as part of the random access procedure, wherein the message triggers transmission of the SRS; and
transmitting the SRS on a SRS resource from the SRS resources in response to the message.

16. The method of claim 15, wherein the configuration of the SRS resources is provided in system information block 1 (SIB1) or the message.

17. The method of claim 15, wherein one of:
the random access procedure is a Type-1 random access procedure and the message is a message four (Msg4) or a contention resolution message of the random access procedure, or
the random access procedure is a Type-2 random access procedure and the message is a message B (MsgB) of the random access procedure.

18. The method of claim 15, wherein the message includes a SRS resource identifier (ID) of the SRS resource that is triggered for transmission.

19. The method of claim 15, further comprising determining a SRS identifier (ID) of the SRS resource triggered for transmission based on (i) a preamble index or (ii) a physical random access channel (PRACH) occasion used for the random access procedure.

20. The method of claim 15, wherein:
the SRS is transmitted in a slot that starts at a time T from a time of reception of the message, and
the time T is configured by a system information block 1 (SIB1).
